(19) United States
(12) Patent Application Publication
(10) Pub. No.: US 2024/0375613 A1
(43) Pub. Date: Nov. 14, 2024

(54) INFORMATION PROCESSING DEVICE, INFORMATION PROCESSING METHOD, RECORDING MEDIUM, AND IN-VEHICLE SYSTEM

(71) Applicant: SONY SEMICONDUCTOR SOLUTIONS CORPORATION, KANAGAWA (JP)

(72) Inventor: RYOJI TAKAGI, KANAGAWA (JP)

(21) Appl. No.: 18/692,351

(22) PCT Filed: Mar. 11, 2022
(86) PCT No.: PCT/JP2022/010847

§ 371 Date: Mar. 15, 2024

(30) Foreign Application Priority Data
Sep. 30, 2021 (JP) 2021-160951

(51) Int. Cl. B60S 1/08; B60S 1/56; G06V 10/75; G06V 10/82; G06V 10/98; G06V 20/58; H04N 23/81

(52) U.S. Cl. CPC B60S 1/0848; B60S 1/56; G06V 10/759; G06V 10/82; G06V 10/993; G06V 20/58; H04N 23/81

(57) ABSTRACT

The present technology relates to an information processing device, an information processing method, a recording medium, and an in-vehicle system capable of suitably recognizing an object using a captured image. An information processing device according to the present technology includes: a first detection unit that detects an adhering substance on a lens of a camera provided in a vehicle from a captured image captured by the camera using a first discriminator using a neural network; a second detection unit that detects the adhering substance from the captured image using a second discriminator using an optical flow; and a region identification unit that identifies a region of the adhering substance in the captured image on the basis of a first detection result by the first detection unit and a second detection result by the second detection unit. The present technology can be applied to, for example, a vehicle that performs automated driving.

### TECHNICAL FIELD

The present technology relates to an information processing device, an information processing method, a recording medium, and an in-vehicle system, and more particularly, to an information processing device, an information processing method, a recording medium, and an in-vehicle system capable of suitably recognizing an object using a captured image.

### BACKGROUND ART

There is a vehicle control system that recognizes an object around a vehicle using a captured image captured by a camera provided outside a vehicle compartment. Since the camera is provided outside the vehicle compartment, there is a possibility that dirt, raindrops, and the like adhere to the lens of the camera, and a technology for detecting these adhering substances is required.

For example, Patent Document 1 describes a technology for detecting an adhering substance on a lens using image change over a certain period of time.

### CITATION LIST

### Patent Document

Patent Document 1: Japanese Patent Application Laid-Open No. 2014-13454

### SUMMARY OF THE INVENTION

### Problems to be Solved by the Invention

In the technology described in Patent Document 1, a captured image for a predetermined time is required to detect the adhering substance. Hence, it is not possible to confirm whether the adhering substance has been wiped off until a predetermined time elapses after the adhering substance has been wiped off. Accordingly, until detection of an adhering substance becomes possible, it is necessary to perform object recognition processing using a captured image on the assumption that the adhering substance has not been wiped off.

In addition, Patent Document 1 describes that false detection caused by an adhering substance is curbed by detecting a lane in a region in a captured image excluding a detected adhering substance region. However, when, for example, important information for detecting the lane overlaps an adhering substance region on a captured image, it is necessary to stop the lane detection, and continuous lane detection and automated travel cannot be achieved.

The present technology has been made in view of such a situation, and is intended to enable suitable recognition of an object using a captured image.

### Solutions to Problems

An information processing device according to a first aspect of the present technology includes: a first detection unit that detects an adhering substance on a lens of a camera provided in a vehicle from a captured image captured by the camera using a first discriminator using a neural network; a second detection unit that detects the adhering substance from the captured image using a second discriminator using an optical flow; and a region identification unit that identifies a region of the adhering substance in the captured image on the basis of a first detection result by the first detection unit and a second detection result by the second detection unit.

An information processing method according to the first aspect of the present technology includes: detecting an adhering substance on a lens of a camera provided in a vehicle from a captured image captured by the camera using a first discriminator using a neural network; detecting the adhering substance from the captured image using a second discriminator using an optical flow; and identifying a region of the adhering substance in the captured image on the basis of a first detection result using the first discriminator and a second detection result using the second discriminator.

A recording medium according to the first aspect of the present technology records a program for performing processing of: detecting an adhering substance on a lens of a camera provided in a vehicle from a captured image captured by the camera using a first discriminator using a neural network; detecting the adhering substance from the captured image using a second discriminator using an optical flow; and identifying a region of the adhering substance in the captured image on the basis of a first detection result using the first discriminator and a second detection result using the second discriminator.

An in-vehicle system according to the first aspect of the present technology includes: a camera that captures an image of a periphery of a vehicle; and an information processing device that includes a first detection unit detecting an adhering substance on a lens of the camera from a captured image captured by the camera using a first discriminator using a neural network, a second detection unit detecting the adhering substance from the captured image using a second discriminator using an optical flow, and a region identification unit identifying a region of the adhering substance in the captured image on the basis of a first detection result by the first detection unit and a second detection result by the second detection unit.

In the first aspect of the present technology, detecting an adhering substance on a lens of a camera provided in a vehicle is detected from a captured image captured by the camera using a first discriminator using a neural network, the adhering substance is detected from the captured image using a second discriminator using an optical flow; and a region of the adhering substance is identified in the captured image on the basis of a first detection result using the first discriminator and a second detection result using the second discriminator.

### BRIEF DESCRIPTION OF DRAWINGS

FIG. 1 is a block diagram illustrating a configuration example of a vehicle control system that is an example of a mobile device control system to which the present technology is applied.

FIG. 2 is a diagram illustrating an example of a sensing region by a camera, a radar, a LiDAR, an ultrasonic sensor, and the like of an external recognition sensor in FIG. 1.

FIG. 3 is a block diagram illustrating a configuration example of the vehicle control system to which the present technology is applied.

FIG. 4 is a block diagram illustrating a detailed configuration example of an AI dirt detection unit and an image-change dirt detection unit.

FIG. 5 is a block diagram illustrating a detailed configuration example of a dirt region identification unit.

FIG. 6 is a flowchart illustrating dirt wiping determination processing performed by the vehicle control system.

FIG. 7 is a diagram illustrating an example of a recognition region set according to the wipe state.

FIG. 8 is a flowchart illustrating image-changed dirt detection processing performed in step S1 of FIG. 6.

FIG. 9 is a diagram illustrating an example of a dirt region acquired using an optical flow.

FIG. 10 is a flowchart illustrating AI dirt detection processing performed in step S2 of FIG. 6.

FIG. 11 is a diagram illustrating an example of a dirt region acquired using a neural network visualization method.

FIG. 12 is a flowchart illustrating dirt region identification processing performed in step S3 of FIG. 6.

FIG. 13 is a diagram illustrating an example of a dirt region identified by a dirt region identification unit.

FIG. 14 is a flowchart illustrating object recognition processing according to a dirt region performed in step S9 of FIG. 6.

FIG. 15 is a diagram illustrating an example in which a part of dirt is wiped off.

FIG. 16 is a flowchart illustrating object recognition processing according to a dirt region in a case where the dirt region covers an object to be recognized on a captured image.

FIG. 17 is a diagram illustrating an example of a captured image in a case where a dirt region covers a lane.

FIG. 18 is a flowchart illustrating object recognition processing according to a dirt region in a case of detecting a traffic light.

FIG. 19 is a diagram illustrating an example of a captured image showing a traffic light and dirt.

FIG. 20 is a block diagram illustrating a configuration example of a vehicle control system.

FIG. 21 is a block diagram illustrating a configuration example of hardware of a computer.

### MODE FOR CARRYING OUT THE INVENTION

Hereinafter, a mode for carrying out the present technology will be described. The description will be given in the following order.
1. Configuration Example of Vehicle Control System
2. Embodiment
3. Modification

### 1. Configuration Example of Vehicle Control System

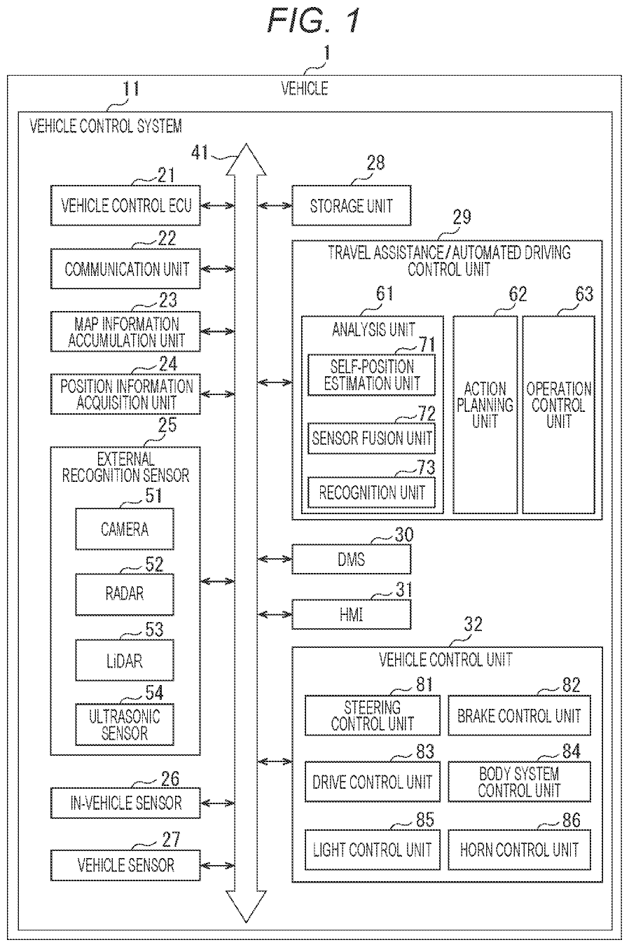

FIG. 1 is a block diagram illustrating a configuration example of a vehicle control system 11, which is an example of a mobile device control system to which the present technology is applied.

The vehicle control system 11 is provided in a vehicle 1 and performs processing related to travel assistance and automated driving of the vehicle 1.

The vehicle control system 11 includes a vehicle control electronic control unit (ECU) 21, a communication unit 22, a map information accumulation unit 23, a position information acquisition unit 24, an external recognition sensor 25, an in-vehicle sensor 26, a vehicle sensor 27, a storage unit 28, a travel assistance/automated driving control unit 29, a driver monitoring system (DMS) 30, a human machine interface (HMI) 31, and a vehicle control unit 32.

The vehicle control ECU 21, the communication unit 22, the map information accumulation unit 23, the position information acquisition unit 24, the external recognition sensor 25, the in-vehicle sensor 26, the vehicle sensor 27, the storage unit 28, the travel assistance/automated driving control unit 29, the driver monitoring system (DMS) 30, the human machine interface (HMI) 31, and the vehicle control unit 32 are communicably connected to each other via a communication network 41. The communication network 41 includes, for example, an in-vehicle communication network, a bus, or the like that conforms to a digital bidirectional communication standard such as controller area network (CAN), local interconnect network (LIN), local area network (LAN), FlexRay (registered trademark), or Ethernet (registered trademark). The communication network 41 may be selectively used depending on the type of data to be transmitted. For example, the CAN may be applied to data related to vehicle control, and the Ethernet may be applied to large-volume data. Note that each unit of the vehicle control system 11 may be directly connected not via the communication network 41 but by, for example, wireless communication that assumes communication at a relatively short distance, such as near field communication (NFC) or Bluetooth (registered trademark).

Note that, hereinafter, in a case where each unit of the vehicle control system 11 performs communication via the communication network 41, description of the communication network 41 is omitted. For example, in a case where the vehicle control ECU 21 and the communication unit 22 perform communication via the communication network 41, it is simply described that the vehicle control ECU 21 and the communication unit 22 perform communication.

For example, the vehicle control ECU 21 includes various processors such as a central processing unit (CPU) and a micro processing unit (MPU). The vehicle control ECU 21 controls all or some of the functions of the vehicle control system 11.

The communication unit 22 communicates with various devices inside and outside the vehicle, other vehicles, servers, base stations, and the like, and transmits and receives various data. At this time, the communication unit 22 can perform communication using a plurality of communication schemes.

A brief description is given of communication with the outside of the vehicle executable by the communication unit 22. The communication unit 22 communicates with a server (hereinafter referred to as an external server) or the like present on an external network via a base station or an access point by, for example, a wireless communication scheme such as fifth generation mobile communication system (5G), long term evolution (LTE), dedicated short range communications (DSRC), or the like. Examples of the external network with which the communication unit 22 performs communication include the Internet, a cloud network, a company-specific network, and the like. A communication scheme performed by the communication unit 22 with respect to the external network is not particularly limited as long as it is a wireless communication scheme capable of performing digital bidirectional communication at a predetermined communication speed or higher at a predetermined distance or longer.

Furthermore, for example, the communication unit 22 can communicate with a terminal present in the vicinity of a host vehicle using a peer to peer (P2P) technology. A terminal present in the vicinity of a host vehicle is, for example, a terminal attached to a moving body moving at a relatively low speed such as a pedestrian, a bicycle, or the like, a terminal fixedly installed in a store or the like, or a machine type communication (MTC) terminal. Moreover, the communication unit 22 can also perform V2X communication. V2X communication refers to, for example, communication between the host vehicle and another vehicle, such as vehicle to vehicle communication with another vehicle, vehicle to infrastructure communication with a roadside device or the like, vehicle to home communication, vehicle to pedestrian communication with a terminal or the like possessed by a pedestrian, or the like.

For example, the communication unit 22 can receive a program for updating software for controlling the operation of the vehicle control system 11 from the outside (Over The Air). The communication unit 22 can further receive map information, traffic information, information regarding the surroundings of the vehicle 1, and the like from the outside. Furthermore, for example, the communication unit 22 can transmit information regarding the vehicle 1, information regarding the surroundings of the vehicle 1, and the like to the outside. Examples of information regarding the vehicle 1 transmitted to the outside by the communication unit 22 include data indicating the state of the vehicle 1, a recognition result from a recognition unit 73, and the like. Moreover, for example, the communication unit 22 performs communication corresponding to a vehicle emergency call system such as an eCall.

For example, the communication unit 22 receives electromagnetic waves transmitted by a road traffic information communication system (vehicle information and communication system (VICS) (registered trademark)) with a radio wave beacon, an optical beacon, FM multiplex broadcasting, or the like.

A brief description is given of communication with the inside of the vehicle executable by the communication unit 22. The communication unit 22 can communicate with each device in the vehicle using, for example, wireless communication. The communication unit 22 can perform wireless communication with a device in the vehicle by, for example, a communication scheme allowing digital bidirectional communication at a predetermined communication speed or higher by wireless communication, such as wireless LAN, Bluetooth, NFC, or wireless USB (WUSB). The present disclosure is not limited thereto, and the communication unit 22 can also communicate with each device in the vehicle using wired communication. For example, the communication unit 22 can communicate with each device in the vehicle by wired communication via a cable connected to a connection terminal (not illustrated). The communication unit 22 can communicate with each device in the vehicle by a communication scheme allowing digital bidirectional communication at a predetermined communication speed or higher by wired communication, such as universal serial bus (USB), high-definition multimedia interface (HDMI) (registered trademark), or mobile high-definition link (MHL).

Here, a device in the vehicle refers to, for example, a device that is not connected to the communication network 41 in the vehicle. As a device in the vehicle, for example, a mobile device or a wearable device carried by an occupant such as a driver or the like, an information device brought into the vehicle and temporarily installed, or the like is assumed.

The map information accumulation unit 23 accumulates one or both of a map acquired from the outside and a map created by the vehicle 1. For example, the map information accumulation unit 23 accumulates a three-dimensional high-precision map, a global map having lower accuracy than the high-precision map and covering a wide area, and the like.

A high-precision map is, for example, a dynamic map, a point cloud map, a vector map, or the like. A dynamic map is, for example, a map including four layers of dynamic information, semi-dynamic information, semi-static information, and static information, and is provided to the vehicle 1 from an external server or the like. A point cloud map is a map including point clouds (point cloud data). A vector map is, for example, a map in which traffic information such as a lane and a position of a traffic light is associated with a point cloud map and adapted to an advanced driver assistance system (ADAS) or autonomous driving (AD).

A point cloud map and a vector map may be provided from, for example, an external server or the like, or may be created by the vehicle 1 as a map for performing matching with a local map to be described later on the basis of a sensing result by a camera 51, a radar 52, a LiDAR 53, or the like, and may be accumulated in the map information accumulation unit 23. Furthermore, in a case where a high-precision map is provided from an external server or the like, for example, map data of several hundred meters square regarding a planned route on which the vehicle 1 travels from now is acquired from the external server or the like in order to reduce the communication amount.

The position information acquisition unit 24 receives a global navigation satellite system (GNSS) signal from a GNSS satellite, and acquires position information of the vehicle 1. The acquired position information is supplied to the travel assistance/automated driving control unit 29. Note that the position information acquisition unit 24 is not limited to the scheme using a GNSS signal, and may acquire position information using, for example, a beacon.

The external recognition sensor 25 includes various sensors used for recognizing an external situation of the vehicle 1, and supplies sensor data from each sensor to each unit of the vehicle control system 11. The type and number of sensors included in the external recognition sensor 25 may be determined as desired.

For example, the external recognition sensor 25 includes the camera 51, the radar 52, the light detection and ranging or laser imaging detection and ranging (LiDAR) 53, and an ultrasonic sensor 54. The present disclosure is not limited thereto, and the external recognition sensor 25 may include one or more types of sensors among the camera 51, the radar 52, the LiDAR 53, and the ultrasonic sensor 54. The numbers of the cameras 51, the radars 52, the LiDAR 53, and the ultrasonic sensors 54 are not particularly limited as long as they can be practically installed in the vehicle 1. Furthermore, the type of sensors included in the external recognition sensor 25 is not limited to this example, and the external recognition sensor 25 may include a sensor of another type. An example of the sensing region of each sensor included in the external recognition sensor 25 will be described later.

Note that the imaging scheme of the camera 51 is not particularly limited. For example, cameras of various imaging methods such as a time of flight (ToF) camera, a stereo camera, a monocular camera, and an infrared camera, which are imaging methods capable of distance measurement, can be applied to the camera 51 as necessary. The present disclosure is not limited thereto, and the camera 51 may simply acquire a captured image regardless of distance measurement.

Furthermore, for example, the external recognition sensor 25 can include an environment sensor for detecting the environment for the vehicle 1. An environment sensor is a sensor for detecting an environment such as weather, climate, and brightness, and can include various sensors such as a raindrop sensor, a fog sensor, a sunshine sensor, a snow sensor, and an illuminance sensor, for example.

Moreover, for example, the external recognition sensor 25 includes a microphone used for detecting a sound around the vehicle 1, a position of a sound source, and the like.

The in-vehicle sensor 26 includes various sensors for detection of information inside the vehicle, and supplies sensor data from each sensor to each unit of the vehicle control system 11. The type and number of various sensors included in the in-vehicle sensor 26 are not particularly limited as long as they are a type and number that can be practically installed in the vehicle 1.

For example, the in-vehicle sensor 26 can include one or more sensors among a camera, a radar, a seating sensor, a steering wheel sensor, a microphone, and a biological sensor. As the camera included in the in-vehicle sensor 26, for example, cameras of various imaging schemes capable of measuring a distance, such as a ToF camera, a stereo camera, a monocular camera, and an infrared camera, can be used. The present disclosure is not limited thereto, and the camera included in the in-vehicle sensor 26 may simply acquire a captured image regardless of distance measurement. The biological sensor included in the in-vehicle sensor 26 is provided, for example, on a seat, a steering wheel, or the like, and detects various types of biological information of an occupant such as a driver.

The vehicle sensor 27 includes various sensors for detecting the state of the vehicle 1, and supplies sensor data from each sensor to each unit of the vehicle control system 11. The type and number of various sensors included in the vehicle sensor 27 are not particularly limited as long as they are a type and number that can be practically installed in the vehicle 1.

For example, the vehicle sensor 27 includes a speed sensor, an acceleration sensor, an angular velocity sensor (gyro sensor), and an inertial measurement unit (IMU) integrating these sensors. For example, the vehicle sensor 27 includes a steering angle sensor that detects a steering angle of a steering wheel, a yaw rate sensor, an accelerator sensor that detects an operation amount of an accelerator pedal, and a brake sensor that detects an operation amount of a brake pedal. For example, the vehicle sensor 27 includes a rotation sensor that detects the number of rotations of an engine or a motor, an air pressure sensor that detects the air pressure of a tire, a slip rate sensor that detects the slip rate of a tire, and a wheel speed sensor that detects the rotation speed of a wheel. For example, the vehicle sensor 27 includes a battery sensor that detects a remaining amount and a temperature of a battery, and an impact sensor that detects an external impact.

The storage unit 28 includes at least one of a nonvolatile storage medium or a volatile storage medium, and stores data and a program. The storage unit 28 is used as, for example, an electrically erasable programmable read only memory (EEPROM) and a random access memory (RAM), and a magnetic storage device such as a hard disc drive (HDD), a semiconductor storage device, an optical storage device, and a magneto-optical storage device can be applied as a storage medium. The storage unit 28 stores various programs and data used by each unit of the vehicle control system 11. For example, the storage unit 28 includes an event data recorder (EDR) and a data storage system for automated driving (DSSAD), and stores information about the vehicle 1 before and after an event such as an accident and information acquired by the in-vehicle sensor 26.

The travel assistance/automated driving control unit 29 controls travel assistance and automated driving of the vehicle 1. For example, the travel assistance/automated driving control unit 29 includes an analysis unit 61, an action planning unit 62, and an operation control unit 63.

The analysis unit 61 performs analysis processing on the vehicle 1 and the situation around the vehicle 1. The analysis unit 61 includes a self-position estimation unit 71, a sensor fusion unit 72, and the recognition unit 73.

The self-position estimation unit 71 estimates the self position of the vehicle 1 on the basis of sensor data from the external recognition sensor 25 and a high-precision map accumulated in the map information accumulation unit 23. For example, the self-position estimation unit 71 generates a local map on the basis of sensor data from the external recognition sensor 25, and estimates the self position of the vehicle 1 by matching the local map with the high-precision map. The position of the vehicle 1 is based on, for example, the center of a rear-wheel axle.

A local map is, for example, a three-dimensional high-precision map created using a technology such as simultaneous localization and mapping (SLAM), or the like, an occupancy grid map, or the like. A three-dimensional high-precision map is, for example, the above-described point cloud map or the like. An occupancy grid map is a map in which a three-dimensional or two-dimensional space around the vehicle 1 is divided into grids (lattices) of a predetermined size, and an occupancy state of an object is represented in units of grids. The occupancy state of an object is represented by, for example, the presence or absence or existence probability of the object. The local map is also used for detection processing and recognition processing of the situation outside the vehicle 1 by the recognition unit 73, for example.

Note that the self-position estimation unit 71 may estimate the self position of the vehicle 1 on the basis of position information acquired by the position information acquisition unit 24 and sensor data from the vehicle sensor 27.

The sensor fusion unit 72 performs sensor fusion processing to obtain new information by combining a plurality of different types of sensor data (for example, image data supplied from the camera 51 and sensor data supplied from the radar 52). Methods for combining different types of sensor data include integration, fusion, association, and the like.

The recognition unit 73 performs detection processing for detecting the situation outside the vehicle 1 and recognition processing for recognizing the situation outside the vehicle 1.

For example, the recognition unit 73 performs detection processing and recognition processing of the situation outside the vehicle 1 on the basis of information from the external recognition sensor 25, information from the self-position estimation unit 71, information from the sensor fusion unit 72, and the like.

Specifically, for example, the recognition unit 73 performs detection processing, recognition processing, and the like of objects around the vehicle 1. Object detection processing is, for example, processing of detecting presence or absence, size, shape, position, movement, and the like of an object. Object recognition processing is, for example, processing of recognizing an attribute such as the type of an object or identifying a specific object. Note, however, that detection processing and recognition processing are not always clearly separated and may overlap.

For example, the recognition unit 73 detects objects around the vehicle 1 by performing clustering to classify point clouds based on sensor data by the radar 52, the LiDAR 53, or the like into clusters of point clouds. Thus, the presence or absence, size, shape, and position of objects around the vehicle 1 are detected.

For example, the recognition unit 73 detects the motion of objects around the vehicle 1 by performing tracking of following the motion of the cluster of point clouds classified by clustering. Thus, the speed and the traveling direction (movement vector) of objects around the vehicle 1 are detected.

For example, the recognition unit 73 detects or recognizes a vehicle, a person, a bicycle, an obstacle, a structure, a road, a traffic light, a traffic sign, a road sign, and the like on the basis of image data supplied from the camera 51. Furthermore, the recognition unit 73 may recognize the type of objects around the vehicle 1 by performing recognition processing such as semantic segmentation.

For example, the recognition unit 73 can perform recognition processing of traffic rules around the vehicle 1 on the basis of a map accumulated in the map information accumulation unit 23, an estimation result of the self position by the self-position estimation unit 71, and a recognition result of objects around the vehicle 1 by the recognition unit 73. With this processing, the recognition unit 73 can recognize the position and the state of the traffic light, the contents of the traffic sign and the road sign, the contents of the traffic regulation, the travelable lane, and the like.

For example, the recognition unit 73 can perform recognition processing on the environment around the vehicle 1. As the surrounding environment to be recognized by the recognition unit 73, weather, temperature, humidity, brightness, road surface conditions, and the like are assumed.

The action planning unit 62 creates an action plan for the vehicle 1. For example, the action planning unit 62 creates an action plan by performing route planning and route following processing.

Note that route planning (global path planning) is processing of planning a general route from the start to the goal. The path planning also includes processing of performing trajectory generation (local path planning) called trajectory planning that enables safe and smooth traveling in the vicinity of the vehicle 1 in consideration of the motion characteristics of the vehicle 1 in the planned path.

Route following is processing of planning an operation for safely and accurately traveling a route planned by route planning within a planned time. For example, the action planning unit 62 can calculate the target speed and the target angular velocity of the vehicle 1 on the basis of a result of the route following processing.

The operation control unit 63 controls operation of the vehicle 1 in order to achieve the action plan created by the action planning unit 62.

For example, the operation control unit 63 controls a steering control unit 81, a brake control unit 82, and a drive control unit 83 included in the vehicle control unit 32 to be described later, and performs acceleration and deceleration control and direction control so that the vehicle 1 travels on the trajectory calculated by trajectory planning. For example, the operation control unit 63 performs coordinated control for the purpose of implementing the functions of the ADAS such as collision avoidance or impact mitigation, follow-up traveling, vehicle-speed maintaining traveling, warning of collision of a host vehicle, warning of lane deviation of a host vehicle, and the like. For example, the operation control unit 63 performs coordinated control for the purpose of automated driving or the like in which the vehicle autonomously travels without depending on the operation of the driver.

The DMS 30 performs authentication processing of a driver, recognition processing of a state of the driver, and the like on the basis of sensor data from the in-vehicle sensor 26, input data input to the HMI 31 to be described later, and the like. As the state of the driver to be recognized, for example, a physical condition, a wakefulness level, a concentration level, a fatigue level, a line-of-sight direction, a drunkenness level, a driving operation, a posture, and the like are assumed.

Note that the DMS 30 may perform authentication processing of an occupant other than the driver and recognition processing of a state of the occupant. Furthermore, for example, the DMS 30 may perform recognition processing of the situation inside a vehicle on the basis of sensor data from the in-vehicle sensor 26. As the situation inside the vehicle to be recognized, for example, temperature, humidity, brightness, odor, and the like are assumed.

The HMI 31 inputs various data, instructions, and the like, and presents various data to the driver and the like.

A brief description is given of data input by the HMI 31. The HMI 31 includes an input device for a person to input data. The HMI 31 generates an input signal on the basis of data, an instruction, or the like input with the input device, and supplies the input signal to each unit of the vehicle control system 11. The HMI 31 includes, for example, an operation element such as a touch panel, a button, a switch, and a lever as the input device. The present disclosure is not limited thereto, and the HMI 31 may further include an input device capable of inputting information by a method such as voice, gesture, or the like other than manual operation. Moreover, the HMI 31 may use, for example, a remote control device using infrared rays or radio waves, or an external connection device such as a mobile device or a wearable device corresponding to the operation of the vehicle control system 11 as the input device.

A brief description is given of data presentation by the HMI 31. The HMI 31 generates visual information, auditory information, and tactile information regarding an occupant or the outside of the vehicle. Furthermore, the HMI 31 performs output control for controlling the output, the output content, the output timing, the output method, and the like of each piece of generated information. The HMI 31 generates and outputs, as visual information, information indicated by image and light such as an operation screen, a display of the state of the vehicle 1, a warning display, and a monitor image indicating the situation around the vehicle 1, for example. In addition, the HMI 31 generates and outputs, as auditory information, information indicated by sound such as a voice guidance, a warning sound, and a warning message, for example. Moreover, the HMI 31 generates and outputs, as tactile information, information given to the tactile sense of the occupant by, for example, force, vibration, motion, or the like.

As an output device with which the HMI 31 outputs visual information, for example, a display device that displays an image by itself to present visual information or a projector device that projects an image to present visual information can be applied. Note that the display device may be a device that displays visual information in the field of view of an occupant, such as a head-up display, a transmissive display, or a wearable device having an augmented reality (AR) function, for example, in addition to a display device having a normal display. Furthermore, the HMI 31 can also use, as an output device for outputting visual information, a display device included in a navigation device, an instrument panel, a camera monitoring system (CMS), an electronic mirror, a lamp, or the like provided in the vehicle 1.

As an output device with which the HMI 31 outputs auditory information, for example, an audio speaker, a headphone, or an earphone can be applied.

As an output device with which the HMI 31 outputs tactile information, for example, a haptic element using a haptic technology can be applied. The haptic element is provided, for example, in a part with which an occupant of the vehicle 1 comes into contact, such as a steering wheel or a seat.

The vehicle control unit 32 controls each unit of the vehicle 1. The vehicle control unit 32 includes the steering control unit 81, the brake control unit 82, the drive control unit 83, a body system control unit 84, a light control unit 85, and a horn control unit 86.

The steering control unit 81 performs detection, control, and the like of the state of a steering system of the vehicle 1. The steering system includes, for example, a steering mechanism including a steering wheel and the like, an electric power steering, and the like. The steering control unit 81 includes, for example, a steering ECU that controls the steering system, an actuator that drives the steering system, and the like.

The brake control unit 82 performs detection, control, and the like of the state of a brake system of the vehicle 1. The brake system includes, for example, a brake mechanism including a brake pedal and the like, an antilock brake system (ABS), a regenerative brake mechanism, and the like. The brake control unit 82 includes, for example, a brake ECU that controls the brake system, an actuator that drives the brake system, and the like.

The drive control unit 83 performs detection, control, and the like of the state of a drive system of the vehicle 1. The drive system includes, for example, an accelerator pedal, a driving force generation device for generating a driving force of an internal combustion engine, a driving motor, or the like, a driving force transmission mechanism for transmitting the driving force to wheels, and the like. The drive control unit 83 includes, for example, a drive ECU that controls the drive system, an actuator that drives the drive system, and the like.

The body system control unit 84 performs detection, control, and the like of the state of a body system of the vehicle 1. The body system includes, for example, a keyless entry system, a smart key system, a power window device, a power seat, an air conditioner, an airbag, a seat belt, a shift lever, and the like. The body system control unit 84 includes, for example, a body system ECU that controls the body system, an actuator that drives the body system, and the like.

The light control unit 85 performs detection, control, and the like of the states of various lights of the vehicle 1. As the lights to be controlled, for example, a headlight, a backlight, a fog light, a turn signal, a brake light, a projection, a bumper display, and the like are assumed. The light control unit 85 includes a light ECU that controls the lights, an actuator that drives the lights, and the like.

The horn control unit 86 performs detection, control, and the like of the state of a car horn of the vehicle 1. The horn control unit 86 includes, for example, a horn ECU that controls the car horn, an actuator that drives the car horn, and the like.

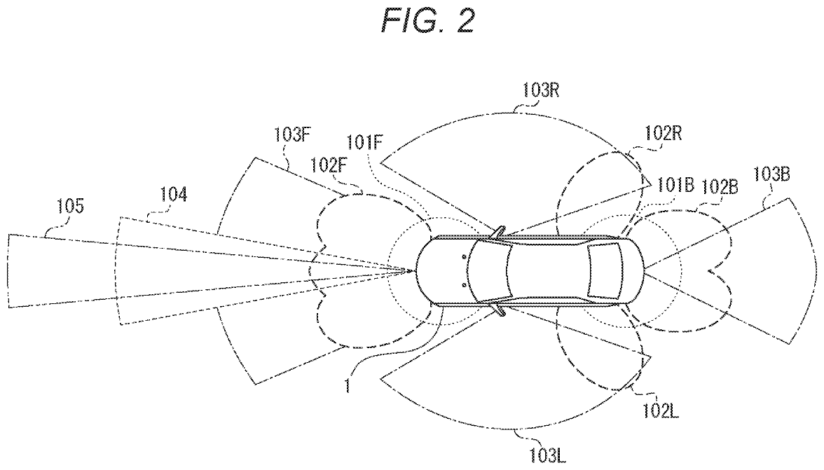

FIG. 2 is a diagram illustrating an example of a sensing region by the camera 51, the radar 52, the LiDAR 53, the ultrasonic sensor 54, and the like of the external recognition sensor 25 in FIG. 1. Note that FIG. 2 schematically illustrates the vehicle 1 as viewed from above, where a left end side is the front end (front) side of the vehicle 1 and a right end side is the rear end (rear) side of the vehicle 1.

A sensing region 101F and a sensing region 101B illustrate examples of sensing regions by the ultrasonic sensor 54. The sensing region 101F covers a region around the front end of the vehicle 1 by a plurality of the ultrasonic sensors 54. The sensing region 101B covers a region around the rear end of the vehicle 1 by a plurality of the ultrasonic sensors 54.

Sensing results in the sensing region 101F and the sensing region 101B are used, for example, for parking assistance and the like of the vehicle 1.

Sensing regions 102F to 102B illustrate examples of sensing regions of the radar 52 for a short distance or a middle distance. The sensing region 102F covers a position farther than the sensing region 101F in front of the vehicle 1. The sensing region 102B covers a position farther than the sensing region 101B behind the vehicle 1. The sensing region 102L covers a region around the rear-left side surface of the vehicle 1. The sensing region 102R covers a region around the rear-right side surface of the vehicle 1.

A sensing result in the sensing region 102F is used, for example, for detection of a vehicle, a pedestrian, or the like present in front of the vehicle 1. A sensing result in the sensing region 102B is used, for example, for a function of preventing a rear collision of the vehicle 1, and the like. Sensing results in the sensing regions 102L and 102R are used, for example, for detection of an object in a blind spot on a side of the vehicle 1, and the like.

Sensing regions 103F to 103B illustrate examples of sensing regions by the camera 51. The sensing region 103F covers a position farther than the sensing region 102F in front of the vehicle 1. The sensing region 103B covers a position farther than the sensing region 102B behind the vehicle 1. The sensing region 103L covers a region around the left side surface of the vehicle 1. The sensing region 103R covers a region around the right side surface of the vehicle 1.

A sensing result in the sensing region 103F can be used, for example, for recognition of a traffic light or a traffic sign, a lane departure prevention assist system, and an automatic headlight control system. A sensing result in the sensing region 103B is used, for example, for parking assistance, a surround view system, and the like. Sensing results in the sensing region 103L and the sensing region 103R can be used for a surround view system, for example.

A sensing region 104 illustrates an example of a sensing region by the LiDAR 53. The sensing region 104 covers a position farther than the sensing region 103F, in front of the vehicle 1. Meanwhile, the sensing region 104 has a narrower range in a left-right direction than the sensing region 103F.

A sensing result in the sensing region 104 is used, for example, for detection of an object such as a surrounding vehicle.

A sensing region 105 illustrates an example of a sensing region of the radar 52 for a long range. The sensing region 105 covers a position farther than the sensing region 104 in front of the vehicle 1. Meanwhile, the sensing region 105 has a narrower range in the left-right direction than the sensing region 104.

A sensing result in the sensing region 105 is used, for example, for adaptive cruise control (ACC), emergency braking, collision avoidance, and the like.

Note that the sensing regions of the sensors of the camera 51, the radar 52, the LiDAR 53, and the ultrasonic sensor 54 included in the external recognition sensor 25 may have various configurations other than those in FIG. 2. Specifically, the ultrasonic sensor 54 may also perform sensing on the sides of the vehicle 1, or the LiDAR 53 may perform sensing behind the vehicle 1. Furthermore, the installation position of each sensor is not limited to each example described above. Furthermore, the number of sensors may be one or more.

### 2. Embodiment

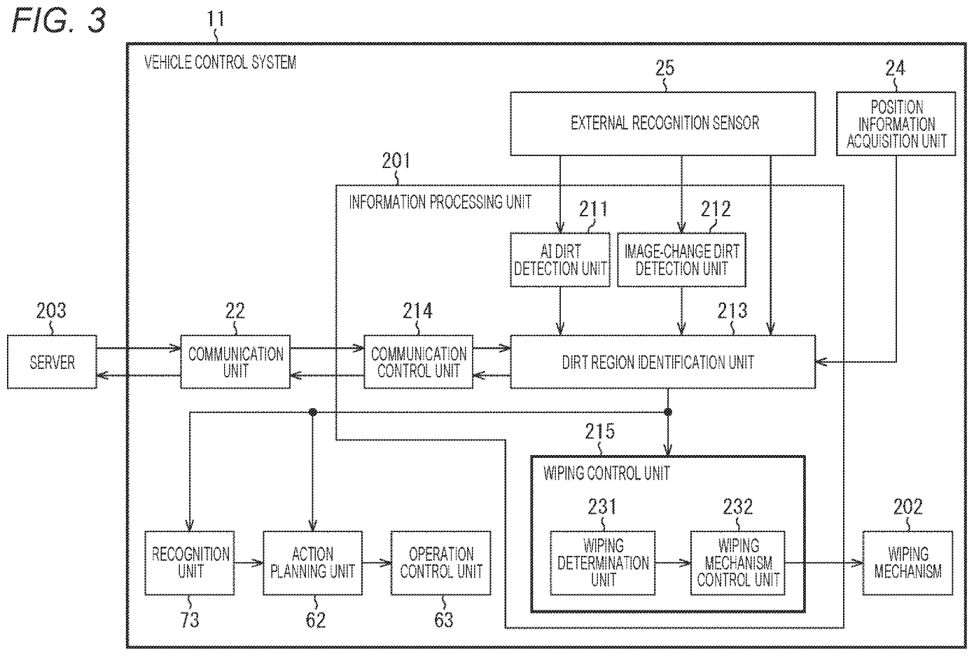

Next, an embodiment of the present technology will be described with reference to FIGS. 3 to 15.

### <Configuration Example of Vehicle Control System>

FIG. 3 is a block diagram illustrating a configuration example of the vehicle control system 11 to which the present technology is applied.

The vehicle control system 11 of FIG. 3 includes an information processing unit 201 that detects an adhering substance on the lens of the camera 51 and a wiping mechanism 202 that wipes off the adhering substance, in addition to the above-described configuration. An adhering substance includes, for example, an obstacle to the camera 51 imaging the periphery of the vehicle 1 such as dirt like mud, a water droplet, and a leaf. Hereinafter, an example in which dirt adhering to the lens is detected as an adhering substance will be described. Note that FIG. 3 illustrates a configuration of a part related to dirt detection in the configuration of the vehicle control system 11.

The information processing unit 201 includes an AI dirt detection unit 211, an image-change dirt detection unit 212, a dirt region identification unit 213, a communication control unit 214, and a wiping control unit 215.

The AI dirt detection unit 211 inputs a captured image captured by the camera 51 of the external recognition sensor 25 to an AI dirt discriminator using a neural network, and detects dirt from the captured image in real time. In the case of detecting dirt, the AI dirt detection unit 211 acquires a dirt region using a visualization method, and supplies the dirt detection result to the dirt region identification unit 213.

The image-change dirt detection unit 212 inputs a captured image captured by the camera 51 of the external recognition sensor 25 to an image-change dirt discriminator using an optical flow, and detects dirt from the captured image. In the case of detecting dirt, the image-change dirt detection unit 212 acquires a dirt region and supplies the dirt detection result to the dirt region identification unit 213.

The dirt region identification unit 213 identifies a dirt region in the captured image on the basis of the dirt detection result by the AI dirt detection unit 211 and the dirt detection result by the image-change dirt detection unit 212, and supplies the captured image and information indicating the dirt region to the action planning unit 62, the recognition unit 73, and the wiping control unit 215. The dirt detection result by the AI dirt detection unit 211 and the image-change dirt detection unit 212 is also supplied from the dirt region identification unit 213 to the wiping control unit 215.

Furthermore, the dirt region identification unit 213 separates an erroneous detection region from a region in the captured image detected as dirt by the AI dirt detection unit 211 or the image-change dirt detection unit 212 on the basis of position information of the vehicle 1 acquired by the position information acquisition unit 24 and sensor data of the external recognition sensor 25. In a case where the AI dirt detection unit 211 erroneously detects dirt or fails to detect dirt, the dirt region identification unit 213 supplies the captured image and information indicating the dirt region to the communication control unit 214.

The communication control unit 214 transmits the captured image and the information indicating the dirt region supplied from the dirt region identification unit 213 to a server 203 via the communication unit 22.

The server 203 performs learning using a neural network and manages a discriminator obtained by the learning. This discriminator is an AI dirt discriminator used by the AI dirt detection unit 211 to detect dirt. The server 203 updates the AI dirt discriminator by performing relearning using a captured image transmitted from the vehicle control system 11 as learning data. Furthermore, the server 203 also manages a history in which the AI dirt discriminator or the image-change dirt discriminator erroneously detects dirt.

The communication control unit 214 acquires a history in which the AI dirt discriminator or the image-change dirt discriminator erroneously detects a region such as a building appearing in the captured image as dirt from the server 203 via the communication unit 22. This history is used by the dirt region identification unit 213 to separate the erroneous detection region from the region in the captured image detected as dirt by the AI dirt detection unit 211 or the image-change dirt detection unit 212.

The wiping control unit 215 includes a wiping determination unit 231 and a wiping mechanism control unit 232.

The wiping determination unit 231 determines whether or not dirt has been wiped off from the lens on the basis of at least one of the dirt detection result by the AI dirt detection unit 211 and the dirt detection result by the image-change dirt detection unit 212.

The wiping mechanism control unit 232 controls the wiping mechanism 202 such as a wiper provided on a front surface of the lens, for example, according to the determination result by the wiping determination unit 231.

The recognition unit 73 recognizes an object around the vehicle 1 using a region in the captured image excluding the dirt region identified by the dirt region identification unit 213 as a recognition region.

In a case where dirt is being wiped or dirt cannot be completely wiped off, the action planning unit 62 creates an action plan for the vehicle 1 so that the dirt region identified by the dirt region identification unit 213 does not overlap information necessary for recognizing objects around the vehicle 1. The action plan of the vehicle 1 is created on the basis of vehicle travel information which is information indicating a travel situation of the vehicle 1.

The operation control unit 63 controls the operation of the vehicle 1 to implement the action plan created by the action planning unit 62, thereby moving the vehicle 1 so that the object and dirt regions around the vehicle 1 do not overlap in the captured image.

Note that the information processing unit 201 may be configured as one information processing device. Furthermore, at least one of the action planning unit 62, the operation control unit 63, the recognition unit 73, and the information processing unit 201 may be configured as one information processing device. Any of these information processing devices may be provided in another device such as the camera 51.

### <Configuration Example of AI Dirt Detection Unit and Image-Change Dirt Detection Unit>

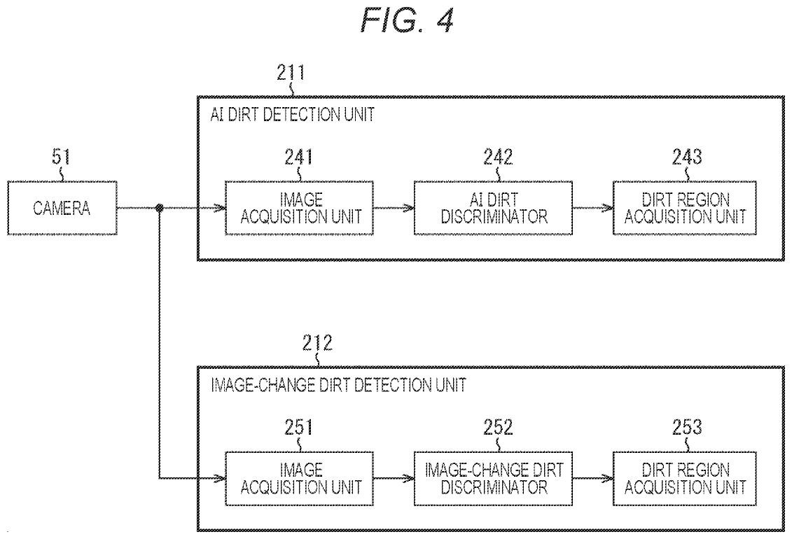

FIG. 4 is a block diagram illustrating a detailed configuration example of the AI dirt detection unit 211 and the image-change dirt detection unit 212.

The AI dirt detection unit 211 includes an image acquisition unit 241, an AI dirt discriminator 242, and a dirt region acquisition unit 243.

The image acquisition unit 241 acquires a captured image captured by the camera 51 and inputs the captured image to the AI dirt discriminator 242.

The AI dirt discriminator 242 is an inference model that determines whether or not there is dirt in the captured image input to the neural network in real time. The AI dirt discriminator 242 is acquired from the server 203 at a predetermined timing and used in the AI dirt detection unit 211.

In a case where the AI dirt discriminator 242 determines that there is dirt in the captured image, the dirt region acquisition unit 243 acquires the basis for determining that there is dirt using a visualization method. For example, by using a technology called Grad-CAM, a heat map indicating the basis for determining that there is dirt is acquired.

The dirt region acquisition unit 243 acquires a dirt region in the captured image on the basis of the determination that there is dirt. For example, the dirt region acquisition unit 243 acquires a region where the level on the heat map is a predetermined value or more as a dirt region. The dirt region acquisition unit 243 supplies information indicating whether or not there is dirt in the captured image and information indicating a dirt region to the dirt region identification unit 213 as a dirt detection result.

The image-change dirt detection unit 212 includes an image acquisition unit 251, an image-change dirt discriminator 252, and a dirt region acquisition unit 253.

The image acquisition unit 251 acquires a captured image captured by the camera 51 and inputs the captured image to the image-change dirt discriminator 252.

The image-change dirt discriminator 252 determines whether or not there is dirt in the input captured image using an optical flow method. Specifically, the image-change dirt discriminator 252 calculates an image change amount of the captured image for a predetermined time, and determines that there is dirt in a case where a region having a small image change amount occupies a predetermined percentage or more of the captured image.

In a case where the image-change dirt discriminator 252 determines that there is dirt in the captured image, the dirt region acquisition unit 253 acquires a region having a small amount of image change in the captured image as a dirt region. The dirt region acquisition unit 253 supplies information indicating whether or not there is dirt in the captured image and information indicating a dirt region to the dirt region identification unit 213 as a dirt detection result.

### <Configuration Example of Dirt Region Identification Unit>

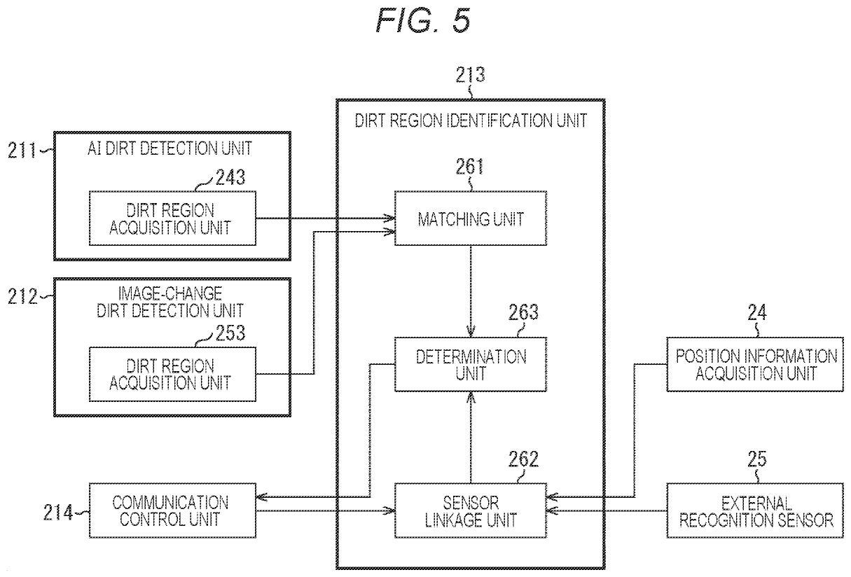

FIG. 5 is a block diagram illustrating a detailed configuration example of the dirt region identification unit 213.

The dirt region identification unit 213 includes a matching unit 261, a sensor linkage unit 262, and a determination unit 263.

The matching unit 261 matches the dirt region detected by the AI dirt detection unit 211 with the dirt region detected by the image-change dirt detection unit 212, and supplies the result of matching to the determination unit 263.

The sensor linkage unit 262 links position information of the vehicle 1 acquired by the position information acquisition unit 24 and sensor data of the external recognition sensor 25 with identification of the dirt region.

For example, the sensor linkage unit 262 identifies a location such as a specific building or wall included in the angle of view of the camera 51 at the self position of the vehicle 1 on the basis of the position information of the vehicle 1 and the sensor data of the external recognition sensor 25. The sensor linkage unit 262 acquires, from the server 203 via the communication control unit 214, a history in which the AI dirt discriminator 242 or the image-change dirt discriminator 252 erroneously detects a region showing the location as dirt. The history in which the AI dirt discriminator 242 or the image-change dirt discriminator 252 detects dirt erroneously is supplied to the determination unit 263.

The determination unit 263 identifies the dirt region in the captured image on the basis of the result of matching by the matching unit 261.

Furthermore, the determination unit 263 separates the erroneous detection region from the region in the captured image detected as dirt by the AI dirt detection unit 211 or the image-change dirt detection unit 212 on the basis of the history of erroneous detection of dirt supplied from the sensor linkage unit 262. In a case where the AI dirt detection unit 211 erroneously detects dirt or fails to detect dirt, the determination unit 263 transmits the captured image and information indicating the dirt region to the server 203 via the communication control unit 214.

### <Dirt Wiping Determination Processing>

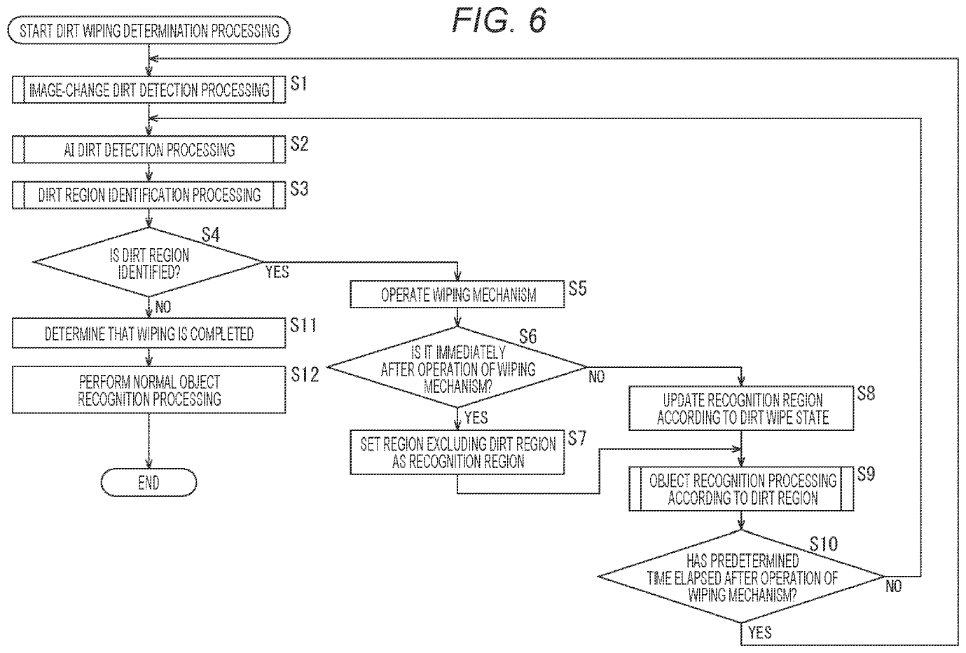

Next, dirt wiping determination processing performed by the vehicle control system 11 will be described with reference to a flowchart of FIG. 6.

The dirt wiping determination processing is started, for example, when an operation for starting the vehicle 1 and starting driving is performed, for example, when an ignition switch, a power switch, a start switch, or the like of the vehicle 1 is turned on. Furthermore, this processing ends, for example, when an operation for ending driving of the vehicle 1 is performed, for example, when an ignition switch, a power switch, a start switch, or the like of the vehicle 1 is turned off.

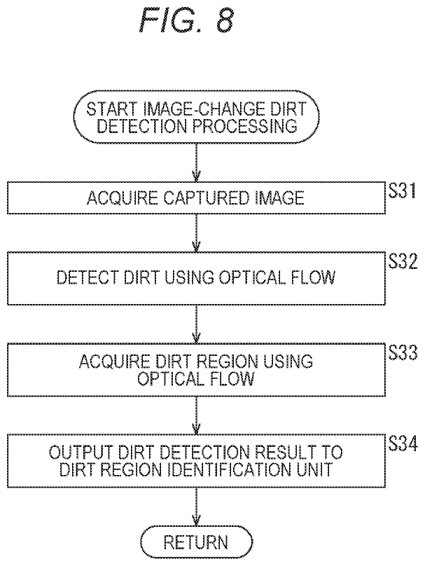

In step S1, the image-change dirt detection unit 212 performs image-change dirt detection processing. By the image-change dirt detection processing, dirt is detected from the captured image using the image-change dirt discriminator 252, and a dirt region is acquired. Details of the image-change dirt detection processing will be described later with reference to FIG. 8.

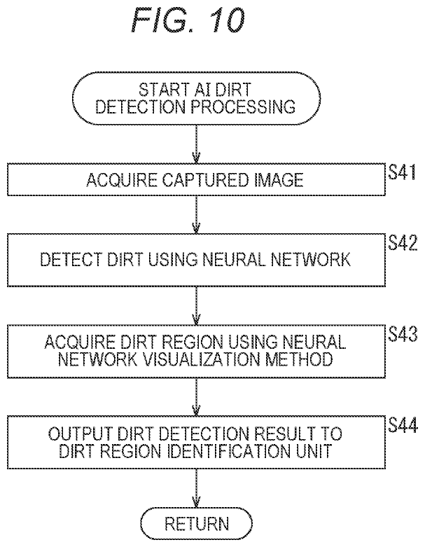

In step S2, the AI dirt detection unit 211 performs AI dirt detection processing. By the AI dirt detection processing, dirt is detected from the captured image using the AI dirt discriminator 242, and a dirt region is acquired. Details of the AI dirt detection processing will be described later with reference to FIG. 10.

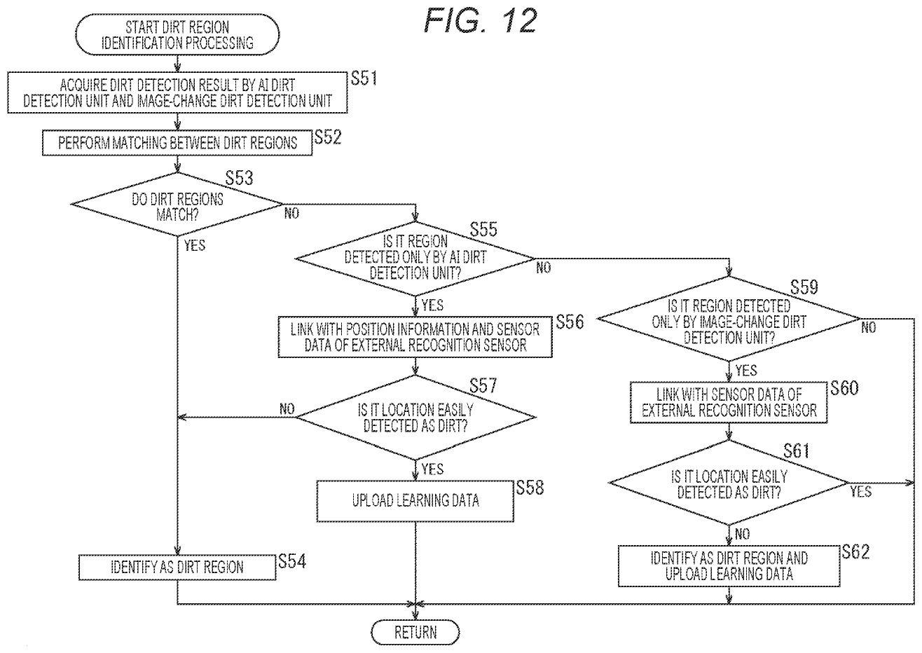

In step S3, the dirt region identification unit 213 performs dirt region identification processing. By the dirt region identification processing, the dirt region in the captured image is identified on the basis of the dirt detection result by the AI dirt detection unit 211 and the dirt detection result by the image-change dirt detection unit 212. Details of the dirt region identification processing will be described later with reference to FIG. 12.

In step S4, the wiping determination unit 231 determines whether or not the dirt region is identified by the dirt region identification unit 213 from the captured image.

In a case where it is determined in step S4 that the dirt region is identified, the wiping mechanism control unit 232 operates the wiping mechanism 202 in step S5.

In step S6, the dirt region identification unit 213 determines whether or not it is immediately after the wiping mechanism 202 is operated.

In a case where it is determined in step S6 that it is immediately after the wiping mechanism 202 is operated, the dirt region identification unit 213 sets a region excluding the dirt region in the captured image as a recognition region in step S7.

On the other hand, in a case where it is determined in step S6 that it is not immediately after the wiping mechanism 202 is operated, the dirt region identification unit 213 updates the recognition region according to the dirt wipe state in step S8.

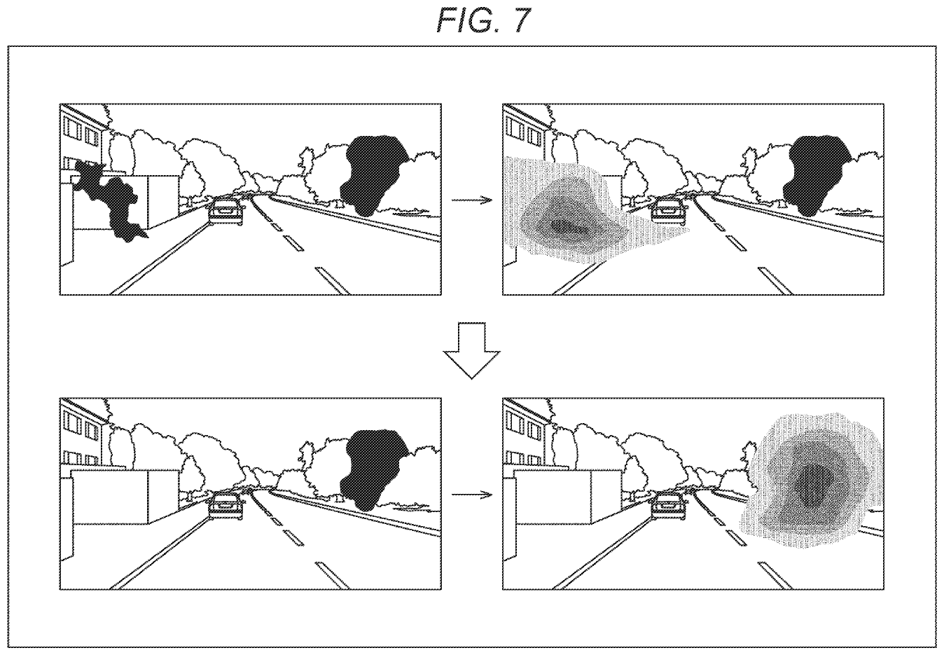

FIG. 7 is a diagram illustrating an example of a recognition region set according to the wipe state.

As illustrated in the upper left of FIG. 7, assume that a captured image showing dirt in left and right two parts is captured. In this case, for example, as illustrated in the heat map in the upper right of FIG. 7, the dirt on the left side is detected by the AI dirt detection unit 211. The dirt region identification unit 213 sets, as a recognition region, a region in the captured image excluding the dirt region acquired on the basis of the heat map.

Next, assume that the wiping mechanism 202 is operated, for example, as illustrated in the lower left of FIG. 7, the dirt on the left side is wiped off, and a captured image showing dirt only on the right side is captured. In this case, as illustrated in the heat map in the lower right of FIG. 7, the dirt on the left side is not detected by the AI dirt detection unit 211.

For example, the wiping determination unit 231 determines whether or not dirt detected before wiping has been wiped off by matching the region detected as dirt before wiping with the region detected as dirt after wiping. The dirt region identification unit 213 updates the region where dirt has been wiped off as a recognition region.

As illustrated in the heat map in the lower right of FIG. 7, in a case where dirt on the right side is newly detected by the AI dirt detection unit 211, the dirt region identification unit 213 updates a region in the captured image excluding this region as a recognition region.

For acquisition of the heat map by the AI dirt detection unit 211, it is desirable to utilize the average region of a predetermined number of frames to curb instantaneous region shift.

Furthermore, if the appearance of dirt changes due to backlight, headlight, or the like, it is assumed that the reaction region of the AI dirt discriminator 242 also changes. For example, in a case where the luminance of the entire captured image increases due to backlight or the like, and the amount of change in the entire captured image becomes equal to or greater than a predetermined value, the determination by the wiping determination unit 231 as to whether or not dirt has been wiped off stops.

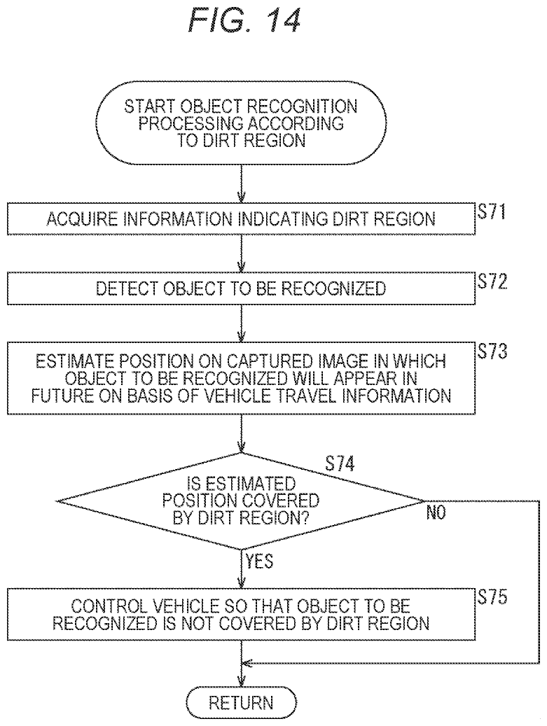

Returning to FIG. 6, in step S9, the vehicle control system 11 performs object recognition processing according to the dirt region. By this processing, objects around the vehicle 1 is recognized in a recognition region excluding the dirt region. Details of the object recognition processing according to the dirt region will be described later with reference to FIG. 14. In step S10, the dirt region identification unit 213 determines whether or not a predetermined time has elapsed after the wiping mechanism 202 is operated.

In a case where it is determined in step S10 that the predetermined time has elapsed after the wiping mechanism 202 is operated, the processing returns to step S1, and the subsequent processing is performed.

On the other hand, in a case where it is determined in step S10 that the predetermined time has not elapsed after the wiping mechanism 202 is operated, the processing returns to step S2 and the subsequent processing is performed.

Since the captured image for a predetermined time is required for the image-change dirt detection unit 212 to detect dirt, it is not possible to confirm whether dirt has been wiped off on the basis of the dirt detection result by the image-change dirt detection unit 212 until a predetermined time elapses after the dirt has been wiped off.

By using only the dirt detection result by the AI dirt detection unit 211 capable of detecting dirt in real time until the image-change dirt detection unit 212 can detect dirt, the wiping determination unit 231 can confirm whether dirt has been wiped off in real time.

In a case where it is determined in step S4 that the dirt region is identified, the wiping determination unit 231 determines in step S11 that wiping of dirt is completed. In a case where the wiping mechanism 202 is operating, for example, the operation of the wiping mechanism 202 is stopped.

In step S12, the vehicle control system 11 performs normal object recognition processing. By this processing, for example, objects around the vehicle 1 are recognized in all regions in the captured image. Note that in a case where the wiping of dirt is not completed even after the wiping mechanism 202 operates a predetermined number of times or more, it is also possible to stop the object recognition processing, display an alert, or safely stop the vehicle 1.

### <Image-Change Dirt Detection Processing>

The image-change dirt detection processing performed in step S1 of FIG. 6 will be described with reference to a flowchart of FIG. 8.

In step S31, the image acquisition unit 251 acquires the captured image captured by the camera 51.

In step S32, the image-change dirt discriminator 252 detects dirt from the captured image using an optical flow.

In step S33, the dirt region acquisition unit 253 acquires a dirt region in the captured image using the optical flow.

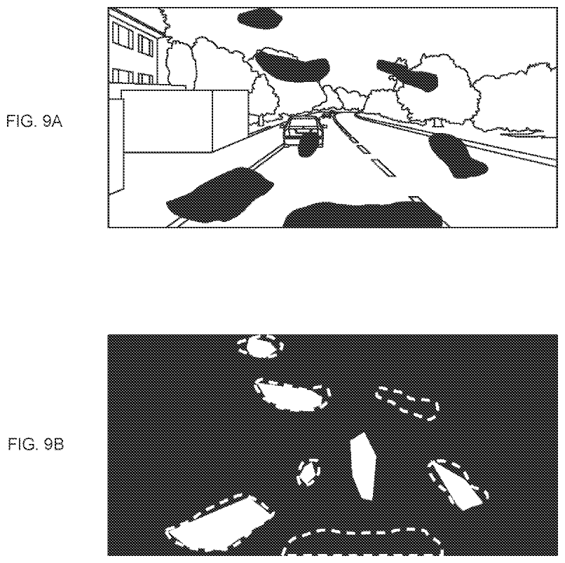

FIG. 9 is a diagram illustrating an example of a dirt region acquired using an optical flow.

As illustrated in A of FIG. 9, assume that a captured image showing dirt in seven parts is captured. In this case, as illustrated in B of FIG. 9, the dirt region acquisition unit 253 acquires, as information indicating the dirt region, a binarized image in which pixel values of pixels forming the dirt region and pixel values of pixels forming a region other than the dirt region are binarized to different values.

In the binarized image in B of FIG. 9, a part indicated in white indicates a region detected as dirt, and a part indicated in black indicates a region other than the dirt region. Furthermore, in the binarized image in B of FIG. 9, regions corresponding to seven parts showing dirt in the captured image are surrounded by broken lines for ease of understanding. Note that in practice, the broken lines surrounding the regions corresponding to dirt are not included in the binarized image.

In the binarized image in B of FIG. 9, four regions showing dirt are detected as dirt, and a partial region showing the road instead of dirt is detected as dirt.

Returning to FIG. 8, in step S34, the dirt region acquisition unit 253 outputs the dirt detection result to the dirt region identification unit 213. Thereafter, the processing returns to step S1 in FIG. 6, and the subsequent processing is performed.

### <AI Dirt Detection Processing>

The AI dirt detection processing performed in step S2 of FIG. 6 will be described with reference to a flowchart of FIG. 10.

In step S41, the image acquisition unit 241 acquires the captured image captured by the camera 51.

In step S42, the AI dirt discriminator 242 detects dirt from the captured image using a neural network.

In step S43, the dirt region acquisition unit 243 acquires a dirt region in the captured image using a neural network visualization method.

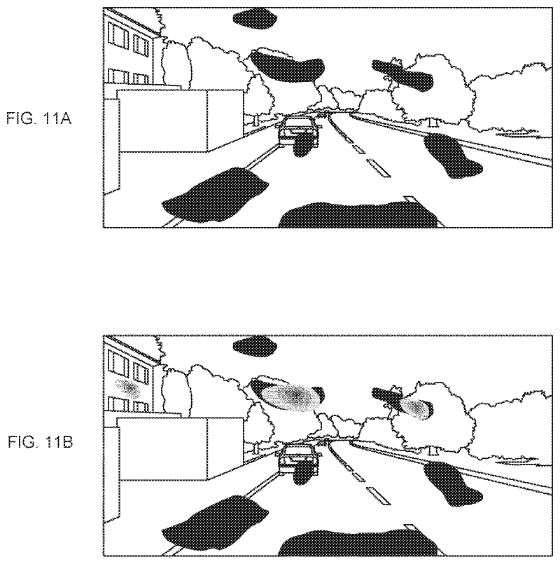

FIG. 11 is a diagram illustrating an example of a dirt region acquired using a neural network visualization method.

As illustrated in A of FIG. 11, assume that a captured image showing dirt in seven parts is captured. In this case, as illustrated in B of FIG. 11, the dirt region acquisition unit 243 acquires a heat map indicating the basis for determining that there is dirt as information indicating the dirt region.

In the heat map of B of FIG. 11, a part indicated by a dark color indicates a region having a high level of basis for determining that there is dirt, and a part indicated by a light color indicates a region having a low level of basis for determining that there is dirt.

In the heat map of B of FIG. 11, two regions showing dirt are detected as dirt, and a partial region showing a wall surface of a building instead of dirt is detected as dirt.

Returning to FIG. 10, in step S44, the dirt region acquisition unit 243 outputs the dirt detection result to the dirt region identification unit 213. Thereafter, the processing returns to step S2 in FIG. 6, and the subsequent processing is performed.

### <Dirt Region Identification Processing>

The dirt region identification processing performed in step S3 of FIG. 6 will be described with reference to a flowchart of FIG. 12.

In step S51, the matching unit 261 acquires a dirt detection result by each of the AI dirt detection unit 211 and the image-change dirt detection unit 212.

In step S52, the matching unit 261 matches the dirt region detected by the AI dirt detection unit 211 with the dirt region detected by the image-change dirt detection unit 212.

In step S53, the determination unit 263 determines whether or not the dirt region detected by the AI dirt detection unit 211 matches the dirt region detected by the image-change dirt detection unit 212.

In a case where it is determined in step S53 that the dirt regions match, the determination unit 263 identifies the matched region as the dirt region in step S54. Thereafter, the processing returns to step S3 in FIG. 6, and the subsequent processing is performed.

On the other hand, in a case where it is determined in step S53 that the dirt regions do not match, the determination unit 263 determines in step S55 whether or not the non-matching region is a region detected as dirt only by the AI dirt detection unit 211.

In a case where it is determined in step S55 that the non-matching region is a region detected as dirt only by the AI dirt detection unit 211, in step S56, the sensor linkage unit 262 links identification of the dirt region with position information of the vehicle 1 and sensor data of the external recognition sensor 25.

Specifically, the sensor linkage unit 262 identifies a location detected as dirt only by the AI dirt detection unit 211 on the basis of position information of the vehicle 1 and sensor data of the external recognition sensor 25, and acquires, from the server 203, a history in which the AI dirt discriminator 242 erroneously detects a region showing the location as dirt.

In step S57, the determination unit 263 determines whether or not a location detected as dirt only by the AI dirt detection unit 211 is a location easily detected as dirt on the basis of the history acquired by the sensor linkage unit 262 from the server 203. For example, in a case where the number of times that the AI dirt discriminator 242 erroneously detects the location as dirt is a predetermined number of times or more, the determination unit 263 determines that the location is easily detected as dirt.

In a case where it is determined in step S57 that the location detected as dirt only by the AI dirt detection unit 211 is not a location easily detected as dirt, the processing proceeds to step S54. Here, the determination unit 263 identifies the region detected as dirt only by the AI dirt detection unit 211 as a dirt region.

On the other hand, in a case where it is determined in step S57 that the location detected as dirt only by the AI dirt detection unit 211 is a location easily detected as dirt, in step S58, the communication control unit 214 uploads a captured image showing the location to the server 203 as learning data.

The server 203 re-learns the captured image showing the region where the AI dirt detection unit 211 detected dirt erroneously as learning data, whereby the AI dirt discriminator 242 can be updated. By updating the AI dirt discriminator 242, it is possible to reduce the chance that the AI dirt discriminator 242 detects a region where no dirt appears as dirt.

When another vehicle 1 on which the same vehicle control system 11 is mounted travels the same position, it is assumed that the AI dirt discriminator 242 erroneously detects the same location as dirt. Accordingly, it is possible to separate a region showing a location easily detected as dirt from a region detected as dirt by the AI dirt detection unit 211.

After learning data is uploaded, the processing returns to step S3 in FIG. 6, and the subsequent processing is performed.

In a case where it is determined in step S55 that the non-matching region is not a region detected as dirt only by the AI dirt detection unit 211, the determination unit 263 determines in step S59 whether or not the region is a region detected as dirt only by the image-change dirt detection unit 212.

In a case where it is determined in step S59 that the non-matching region is a region detected as dirt only by the image-change dirt detection unit 212, in step S60, the sensor linkage unit 262 links identification of the dirt region with position information of the vehicle 1 and sensor data of the external recognition sensor 25.

Specifically, the sensor linkage unit 262 identifies a location detected as dirt only by the image-change dirt detection unit 212 on the basis of position information of the vehicle 1 and sensor data of the external recognition sensor 25, and acquires, from the server 203, a history in which the image-change dirt discriminator 252 erroneously detects a region showing the location as dirt.

In step S61, the determination unit 263 determines whether or not a location detected as dirt only by the image-change dirt detection unit 212 is a location easily detected as dirt on the basis of the history acquired by the sensor linkage unit 262 from the server 203. For example, in a case where the number of times that the image-change dirt discriminator 252 erroneously detects the location detected as dirt only by the image-change dirt detection unit 212 as dirt is a predetermined number of times or more, the determination unit 263 determines that the location is easily detected as dirt.

In a case where it is determined in step S61 that the location detected as dirt only by the image-change dirt detection unit 212 is not a location easily detected as dirt, in step S62, the determination unit 263 identifies the region detected as dirt only by the image-change dirt detection unit 212 as a dirt region. The communication control unit 214 uploads the captured image showing the location to the server 203 as learning data.

The server 203 re-learns, as learning data, the captured image showing the region where only the image-change dirt detection unit 212 detected dirt, that is, the region where the AI dirt detection unit 211 could not detect dirt, whereby the AI dirt discriminator 242 can be updated. By updating the AI dirt discriminator 242, it is possible to reduce the chance that the AI dirt discriminator 242 cannot detect a region showing dirt as dirt.

After learning data is uploaded, the processing returns to step S3 in FIG. 6, and the subsequent processing is performed.

In a case where it is determined in step S57 that the location detected as dirt only by the image dirt detection unit 212 is a location easily detected as dirt, the region showing the location easily detected as dirt is separated from the region detected as dirt by the image-change dirt detection unit 212.

When another vehicle 1 on which the same vehicle control system 11 is mounted travels the same position, it is assumed that the image-change dirt discriminator 252 erroneously detects dirt at the same location. Accordingly, in the region detected by the image-change dirt detection unit 212 as the dirt region, it is possible to separate a region showing a location easily detected as dirt from the dirt region.

After the region showing the location easily detected as dirt is separated, the processing returns to step S3 in FIG. 6, and the subsequent processing is performed.

In a case where it is determined in step S59 that the non-matching region is not a region detected as dirt only by the image-change dirt detection unit 212, the region is determined as a region other than the dirt region. Thereafter, the processing returns to step S3 in FIG. 6, and the subsequent processing is performed.

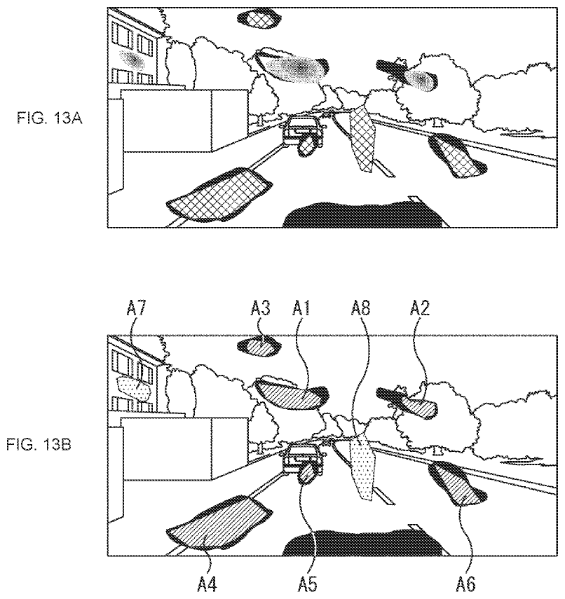

FIG. 13 is a diagram illustrating an example of a dirt region identified by the dirt region identification unit 213.

In A of FIG. 13, a region detected by the AI dirt detection unit 211 as a dirt region as described with reference to B of FIG. 11 and a region detected by the image-change dirt detection unit 212 as a dirt region as described with reference to B of FIG. 9 are illustrated in an overlapping manner. Note that in A of FIG. 13, the region detected by the image-change dirt detection unit 212 is hatched.

A region A1 and a region A2 illustrated in B of FIG. 13, which are detected as dirt by both the AI dirt detection unit 211 and the image-change dirt detection unit 212, are identified as dirt regions. Regions A3 to A6 detected as dirt only by the image-change dirt detection unit 212 are also identified as dirt regions.

As described above, the dirt region identification unit 213 identifies a region in the captured image detected as dirt by at least one of the AI dirt detection unit 211 and the image-change dirt detection unit 212 as a dirt region.

A region A7 showing the wall surface of the building although detected as dirt only by the AI dirt detection unit 211 is separated from the dirt region as a region of a location easily detected as dirt by the AI dirt discriminator 242. A region A8 showing the road although detected as dirt only by the image-change dirt detection unit 212 is separated from the dirt region as a region of a location easily detected as dirt by the image-change dirt discriminator 252.

In this way, by linking identification of the dirt region with position information of the vehicle 1 and sensor data of the external recognition sensor 25, it is possible to reduce the chance of determining that a region showing no dirt is a dirt region.

### <Object Recognition Processing According to Dirt Region>

The object recognition processing according to the dirt region performed in step S9 of FIG. 6 will be described with reference to a flowchart of FIG. 14.

In step S71, the action planning unit 62 acquires information indicating a dirt region from the dirt region identification unit 213.

In step S72, the recognition unit 73 detects an object to be recognized from the recognition region.

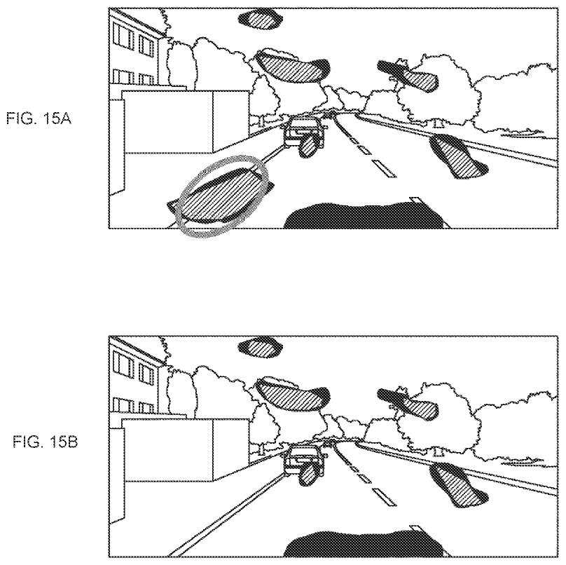

Until dirt is no longer detected from the captured image, the recognition unit 73 detects an object to be recognized using a region other than the dirt region as a recognition region in order to curb erroneous detection. For example, as surrounded by an ellipse in A of FIG. 15, in a case where dirt covers a lane (white line) as an object to be recognized on the captured image, the recognition unit 73 detects the lane within a region excluding the dirt region.

In a case where the dirt covering the lane on the captured image is wiped off by an operation of the wiping mechanism 202 as illustrated in B of FIG. 15, the recognition unit 73 can restore the recognition of the object in the region where the dirt has been wiped off.

In step S73, the action planning unit 62 estimates a position on the captured image in which the object to be recognized will appear in the future on the basis of vehicle travel information.

In step S74, the action planning unit 62 determines whether or not the position on the captured image in which the object to be recognized will appear in the future is covered by the dirt region.

In a case where it is determined in step S74 that the position on the captured image in which the object to be recognized will appear in the future is covered by the dirt region, in step S75, the operation control unit 63 controls the vehicle 1 so that the object to be recognized is not covered by the dirt region.

After the vehicle 1 is controlled in step S74, or in a case where it is determined in step S74 that the position on the captured image in which the object to be recognized will appear in the future is not covered by the dirt region, the processing returns to step S9 in FIG. 6, and the subsequent processing is performed.

Generally, in a case where important information for detecting a lane is covered by a dirt region, detection of the lane has to be stopped. In a case where it is estimated in advance that important information for detecting a lane will be covered by a dirt region, the vehicle control system 11 of the present technology can control the vehicle 1 to prevent overlap of the information for detecting the lane and the dirt region.

As a result, even in a case where dirt adheres to the lens of the camera 51 or in a case where the dirt cannot be wiped off, it is possible to achieve continuous lane detection and automated travel without stopping lane detection.

### 3. Modification

### <Overlap of Dirt Region and Object to be Recognized on Captured Image>

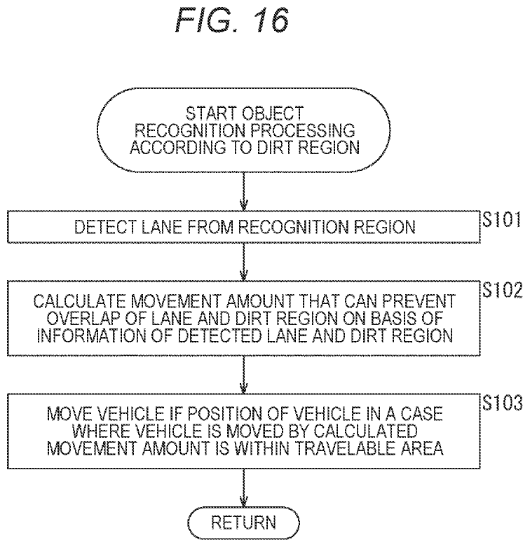

Object recognition processing according to the dirt region in a case where the dirt region covers the object to be recognized on the captured image will be described with reference to a flowchart of FIG. 16. The processing of FIG. 16 is processing performed in step S9 of FIG. 6.

In step S101, the recognition unit 73 detects a lane as an object to be recognized from the recognition region.

In step S102, the action planning unit 62 calculates the movement amount of the vehicle 1 that can prevent overlap of the lane and the dirt region on the captured image on the basis of information of the detected lane and the dirt region.

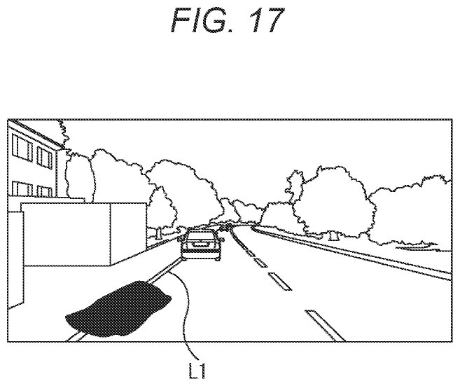

FIG. 17 is a diagram illustrating an example of a captured image in a case where a dirt region covers a lane.

For example, in a traveling scene or an automatic parking scene, as illustrated in FIG. 17, in a case where a dirt region covers a part of a lane L1 on the captured image, the lane L1 in the dirt region cannot be detected. The action planning unit 62 calculates the amount of overlap of the dirt region and the lane L1 on the captured image on the basis of information of the lane L1 detected from a region other than the dirt region. For example, the action planning unit 62 calculates a thickness corresponding to three lanes L1 as the amount of overlap of the dirt region and the lane.

Returning to FIG. 16, in step S103, if the position of the vehicle 1 in a case where the vehicle 1 is moved by the movement amount calculated by the action planning unit 62 is within a travelable area, the operation control unit 63 moves the vehicle 1. In the case described with reference to FIG. 17, the operation control unit 63 moves the vehicle 1 to the right by the thickness corresponding to three lanes, so that the lane can be shown in a region other than the dirt region.

After the vehicle 1 is moved in step S103, the processing returns to step S9 in FIG. 6, and the subsequent processing is performed.

As described above, even in a case where the object to be recognized is covered by the dirt region on the captured image, the vehicle control system 11 can control the vehicle 1 so that the object to be recognized appears in a region other than the dirt region.

### <Detection of Traffic Light>

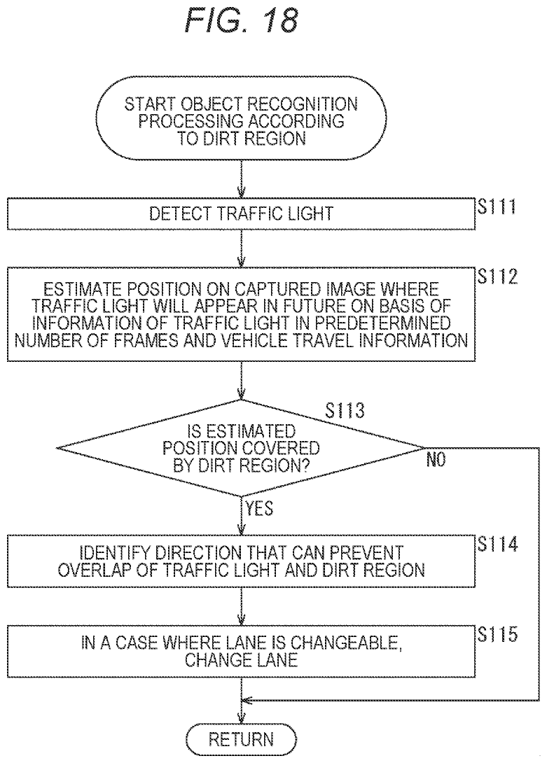

Object recognition processing according to the dirt region in a case where a traffic light is detected as the object to be recognized will be described with reference to a flowchart of FIG. 18. The processing of FIG. 18 is processing performed in step S9 of FIG. 6.

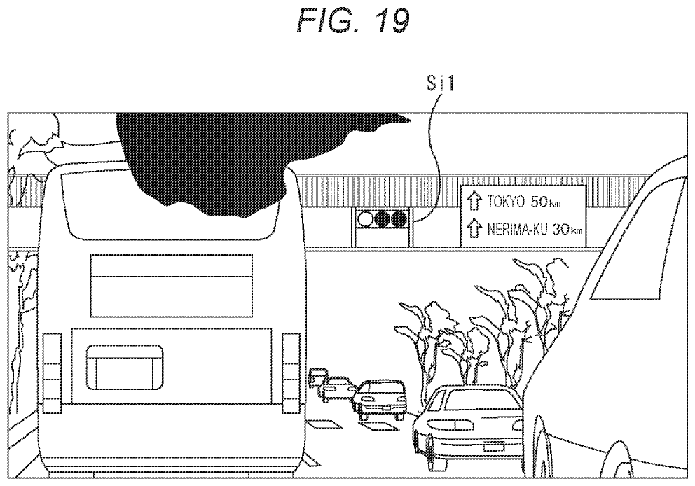

For example, in an intersection scene, as illustrated in FIG. 19, assume that a captured image showing dirt on the upper left side is captured. If a traffic light Si1 is covered by the dirt region, the traffic light Si1 cannot be continuously detected, so that continuous traveling cannot be achieved.

In order to prevent overlap of the traffic light Si1 and the dirt region, in step S111, the recognition unit 73 detects the traffic light Si1 from the recognition region.

In step S112, the action planning unit 62 estimates the position on the captured image where the traffic light Si1 will appear in the future on the basis of information of the traffic light Si1 detected in a predetermined number of frames and vehicle travel information.

In step S113, the action planning unit 62 determines whether or not the position on the captured image where the traffic light Si1 will appear in the future is covered by the dirt region.

In a case where it is determined in step S113 that the position on the captured image where the traffic light Si1 will appear in the future is covered by the dirt region, in step S114, the action planning unit 62 identifies a direction that can prevent overlap of the traffic light Si1 and the dirt region on the captured image. In the case described with reference to FIG. 19, the action planning unit 62 determines that the right direction on the captured image is a direction that can prevent overlap of the traffic light Si1 and the dirt region on the captured image.

In step S115, in a case where the lane is changeable, the operation control unit 63 changes the lane on which the vehicle 1 travels. In a case where the lane is not changeable, the vehicle 1 may be stopped when there is a position where the vehicle 1 can be stopped nearby.

After the lane change, or in a case where it is determined in step S113 that the position on the captured image in which the traffic light Si1 will appear in the future is not covered by the dirt region, the processing returns to step S9 in FIG. 6, and the subsequent processing is performed.

As described above, in a case where it is predicted that the traffic light will be covered by a dirt region on the captured image, the vehicle control system 11 can continuously detect the traffic light by changing the lane or controlling the stop position so that the traffic light appears in a region other than the dirt region. This makes it possible to achieve continuous traveling.

### <Detection of Backlight>

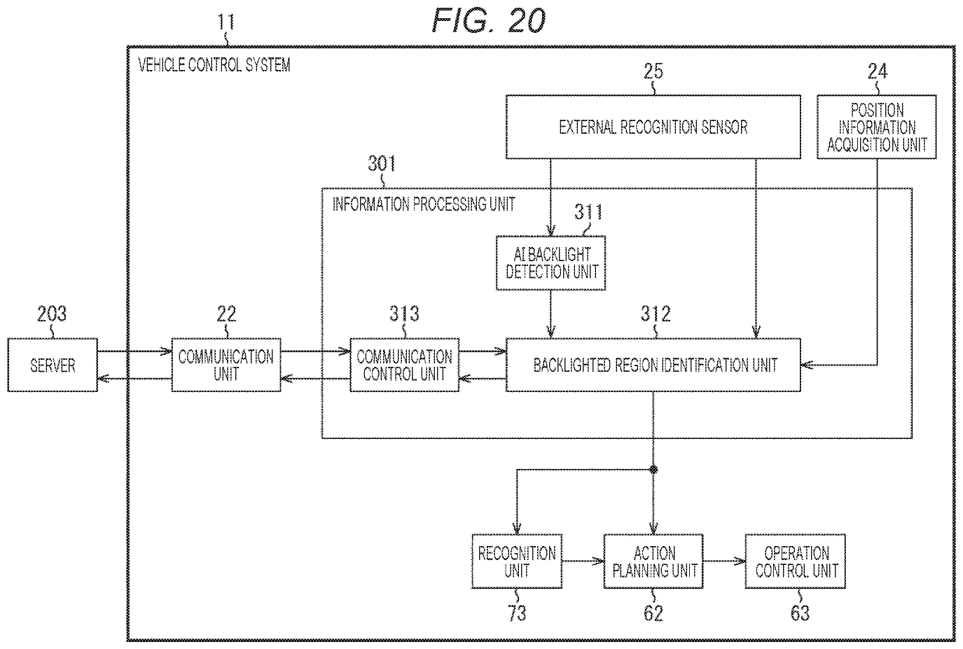

FIG. 20 is a block diagram illustrating a configuration example of the vehicle control system 11.

The vehicle control system 11 described with reference to FIG. 3 and other drawings is provided with a configuration for detecting an adhering substance such as dirt on the lens from a captured image and a configuration for wiping off the adhering substance. On the other hand, in the vehicle control system 11 of FIG. 20, a configuration for detecting a backlighted region is provided.

In FIG. 20, the same components as those described with reference to FIG. 3 are denoted by the same reference signs. The configuration of the vehicle control system 11 of FIG. 20 is different from the configuration of the vehicle control system 11 of FIG. 3 in that an information processing unit 301 is provided instead of the information processing unit 201 and the wiping mechanism 202 is not provided.

The information processing unit 301 includes an AI backlight detection unit 311, a backlighted region identification unit 312, and a communication control unit 313.

The AI backlight detection unit 311 inputs a captured image captured by the camera 51 of the external recognition sensor 25 to an AI backlight discriminator using a neural network, and detects backlight from the captured image in real time. In a case where backlight is detected, the AI backlight detection unit 311 acquires a backlighted region using a visualization method, and supplies the backlight detection result to the backlighted region identification unit 312.

The backlighted region identification unit 312 identifies the backlighted region in the captured image on the basis of the dirt detection result by the AI backlight detection unit 311, and supplies the captured image and information indicating the backlighted region to the action planning unit 62 and the recognition unit 73.

Furthermore, the backlighted region identification unit 312 separates an erroneous detection region from the region in the captured image detected as backlight by the AI backlight detection unit 311 on the basis of position information of the vehicle 1 acquired by the position information acquisition unit 24 and sensor data of the external recognition sensor 25. In a case where the AI backlight detection unit 311 erroneously detects backlight, the backlighted region identification unit 312 supplies the captured image and information indicating the backlighted region to the communication control unit 313.

The communication control unit 313 transmits the captured image and information indicating the backlighted region supplied from the backlighted region identification unit 312 to the server 203 via the communication unit 22.

The server 203 performs learning using a neural network and manages a discriminator obtained by the learning. This discriminator is an AI backlight discriminator used by the AI backlight detection unit 311 to detect backlight. The server 203 updates the AI backlight discriminator by performing relearning using a captured image transmitted from the vehicle control system 11 as learning data. Furthermore, the server 203 also manages a history in which the AI backlight discriminator erroneously detects backlight.

The communication control unit 313 acquires a history in which the AI backlight discriminator erroneously detects dirt at a location included in the angle of view of the camera 51 at the self position of the vehicle 1 from the server 203 via the communication unit 22. This history is used by the backlighted region identification unit 312 to separate the erroneous detection region from the region in the captured image detected as backlight by the AI backlight detection unit 311.

The recognition unit 73 recognizes an object around the vehicle 1 using a region in the captured image excluding the backlighted region identified by the backlighted region identification unit 312 as a recognition region.

The action planning unit 62 creates an action plan for the vehicle 1 on the basis of vehicle travel information so that the backlighted region identified by the backlighted region identification unit 312 does not overlap information necessary for recognizing objects around the vehicle 1.

The operation control unit 63 controls the operation of the vehicle 1 to implement the action plan created by the action planning unit 62, thereby moving the vehicle 1 so that the object and backlighted regions around the vehicle 1 do not overlap in the captured image.

For example, in an intersection scene, if a traffic light is covered by a backlighted region, the traffic light cannot be continuously detected, so that continuous traveling cannot be achieved.

For example, in a case where the recognition unit 73 had detected a traffic light but the traffic light becomes undetectable as the vehicle 1 approaches an intersection, in a case where the backlighted region identified by the backlighted region identification unit 312 is close to the traffic light, there is a high possibility that the cause of failure to detect the traffic light is backlight. In this case, the operation control unit 63 changes the lane if the lane is changeable, so that it is possible to avoid inability to detect the traffic light due to backlight.

### <Other>

In the example described above, the description has been given assuming that the dirt region acquisition unit 243 acquires a heat map indicating the basis for determining that there is dirt using the Grad-CAM technology as a neural network visualization method. It is also possible for the dirt region acquisition unit 243 to acquire information indicating the basis for determining that there is dirt using another visualization method according to a demand for processing time or performance.

In the example described above, the description has been given assuming that the dirt region identification unit 213 identifies the dirt region after the wiping mechanism 202 operates. As a result, the erroneous detection region by the AI dirt detection unit 211 or the image-change dirt detection unit 212 can be separated. Accordingly, the performance of detecting dirt can be improved.

In a case where the dirt region identification unit 213 identifies the dirt region, the processing time of the processing of separating the erroneous detection region is required, and thus the processing time of the entire information processing unit 201 becomes long. After the wiping mechanism 202 operates when the dirt region identification unit 213 identifies the dirt region, depending on the processing time and performance requirements, the wiping determination unit 231 may identify the dirt region and not separate the erroneously detected dirt region.

### <Computer>

The above-described series of processing can be performed by hardware or can be performed by software. In a case where the series of processing is performed by software, a program constituting the software is installed on a computer built into dedicated hardware, a general-purpose personal computer, or the like from a program recording medium.

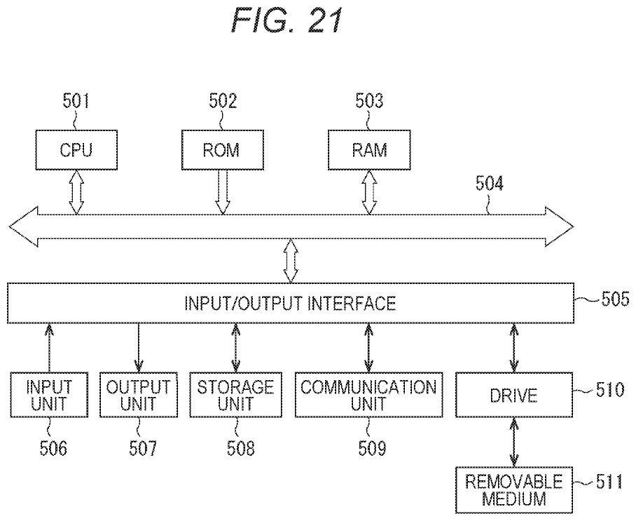

FIG. 21 is a block diagram illustrating a configuration example of hardware of a computer that performs the above-described series of processing by a program. A transmission control device 101 and an information processing device 113 include, for example, a PC having a configuration similar to the configuration illustrated in FIG. 21.

A central processing unit (CPU) 501, a read only memory (ROM) 502, and a random access memory (RAM) 503 are connected to each other by a bus 504.

An input/output interface 505 is further connected to the bus 504. An input unit 506 including a keyboard, a mouse, and the like, and an output unit 507 including a display, a speaker, and the like are connected to the input/output interface 505. Furthermore, a storage unit 508 including a hard disk, a nonvolatile memory, and the like, a communication unit 509 including a network interface and the like, and a drive 510 that drives a removable medium 511 are connected to the input/output interface 505.

In the computer configured as described above, for example, the CPU 501 loads a program stored in the storage unit 508 into the RAM 503 via the input/output interface 505 and the bus 504 and executes the program to perform the above-described series of processing.

For example, the program to be executed by the CPU 501 is stored in the removable medium 511, or provided via a wired or wireless transmission medium such as a local area network, the Internet, or digital broadcasting, and then installed in the storage unit 508.

The program executed by the computer may be a program in which the processing is performed in time series in the order described in the present description, or may be a program in which the processing is performed in parallel or at a necessary timing such as when a call is made.

Note that in the present description, a system means an assembly of a plurality of components (devices, modules (parts), and the like), and it does not matter whether or not all the components are located in the same housing. Accordingly, a plurality of devices housed in separate housings and connected via a network and one device in which a plurality of modules is accommodated in one housing are both systems.

Note that the effects described in the present specification are merely examples and are not restrictive, and there may be other effects.

Embodiments of the present technology are not limited to the above-described embodiment, and various modifications may be made without departing from the gist of the present technology.

For example, the present technology may be configured as cloud computing in which one function is shared by a plurality of devices over the network to process together.

Furthermore, each of the steps in the flowcharts described above can be executed by one device or executed by a plurality of devices in a shared manner.

Moreover, in a case where a plurality of types of processing is included in one step, the plurality of types of processing included in the one step can be executed by one device or shared and performed by a plurality of devices.

### <Combination Example of Configuration>

The present technology may also have the following configurations.
(1)
An information processing device including:
a first detection unit that detects an adhering substance on a lens of a camera provided in a vehicle from a captured image captured by the camera using a first discriminator using a neural network;
a second detection unit that detects the adhering substance from the captured image using a second discriminator using an optical flow; and
a region identification unit that identifies a region of the adhering substance in the captured image on the basis of a first detection result by the first detection unit and a second detection result by the second detection unit.
(2)
The information processing device according to (1), in which
the region identification unit identifies, as a region of the adhering substance, a region in the captured image detected as the adhering substance by at least one of the first detection unit or the second detection unit.
(3)
The information processing device according to (2), in which
the region identification unit identifies, as a region of the adhering substance, a region in which a region in the captured image detected as the adhering substance by the first detection unit matches a region in the captured image detected as the adhering substance by the second detection unit.
(4)
The information processing device according to (3), in which
on the basis of sensor data of an external recognition sensor used to recognize a situation outside the vehicle, the region identification unit separates a first erroneous detection region that is an erroneous detection region from a region in the captured image detected as the adhering substance by the first detection unit and separates a second erroneous detection region that is an erroneous detection region from a region in the captured image detected as the adhering substance by the second detection unit as the adhering substance.
(5)
The information processing device according to (4), further including a communication control unit that transmits the captured image including the first erroneous detection region to a server that performs learning using the neural network.
(6)
The information processing device according to (5), in which
the communication control unit transmits the captured image including a region that is not detected by the first detection unit as a region of the adhering substance and is detected by the second detection unit as a region of the adhering substance to the server.
(7)
The information processing device according to (6), in which
the first detection unit detects the adhering substance from the captured image using the first discriminator obtained by learning using the captured image transmitted to the server as learning data.
(8)
The information processing device according to any one of (1) to (7), further including a wiping control unit that controls a wiping mechanism for wiping off the adhering substance according to the first detection result and the second detection result.
(9)
The information processing device according to (8), in which
after operating the wiping mechanism, the wiping control unit determines whether or not the adhering substance has been wiped off on the basis of at least one of the first detection result or the second detection result.
(10)
The information processing device according to (9), in which
the wiping control unit determines whether or not the adhering substance has been wiped off on the basis of only the first detection result for a predetermined period after the wiping mechanism is operated.
(11)
The information processing device according to (9) or (10), in which
the region identification unit sets a region excluding a region of the adhering substance in the captured image as a recognition region used for recognizing an object around the vehicle.
(12)
The information processing device according to (11), in which
the region identification unit updates a region where the wiping control unit determines that the adhering substance has been wiped off as the recognition region.
(13)
The information processing device according to (11) or (12), further including a recognition unit that recognizes the object from the recognition region of the captured image.
(14)
The information processing device according to any one of (11) to (13), further including an operation control unit that controls an operation of the vehicle on the basis of the region of the adhering substance identified by the region identification unit.
(15)
The information processing device according to (14), in which
the operation control unit moves the vehicle in a direction in which the object within an angle of view of the captured image and outside the recognition region appears in the recognition region.
(16)
The information processing device according to (14) or (15), in which
the operation control unit moves the vehicle in a direction in which the object in the recognition region of the captured image is estimated to appear in the recognition region in the future.
(17)
An information processing method including:
detecting an adhering substance on a lens of a camera provided in a vehicle from a captured image captured by the camera using a first discriminator using a neural network;
detecting the adhering substance from the captured image using a second discriminator using an optical flow; and
identifying a region of the adhering substance in the captured image on the basis of a first detection result using the first discriminator and a second detection result using the second discriminator.
(18)
A computer-readable recording medium recording a program for performing processing of:
detecting an adhering substance on a lens of a camera provided in a vehicle from a captured image captured by the camera using a first discriminator using a neural network;
detecting the adhering substance from the captured image using a second discriminator using an optical flow; and
identifying a region of the adhering substance in the captured image on the basis of a first detection result using the first discriminator and a second detection result using the second discriminator.
(19)
An in-vehicle system including:
a camera that captures an image of a periphery of a vehicle; and
an information processing device that includes
a first detection unit detecting an adhering substance on a lens of the camera from a captured image captured by the camera using a first discriminator using a neural network,
a second detection unit detecting the adhering substance from the captured image using a second discriminator using an optical flow, and
a region identification unit identifying a region of the adhering substance in the captured image on the basis of a first detection result by the first detection unit and a second detection result by the second detection unit.
(20)
An information processing device including:
a detection unit that detects a backlighted region from a captured image captured by a camera provided in a vehicle using a discriminator using a neural network;
a region identification unit that identifies the backlighted region in the captured image on the basis of a detection result by the detection unit; and
an operation control unit that controls an operation of the vehicle on the basis of the backlighted region identified by the region identification unit.

### REFERENCE SIGNS LIST

1 Vehicle
11 Vehicle control system
22 Communication unit
24 Position information acquisition unit
25 External recognition sensor
51 Camera
62 Action planning unit
63 Operation control unit
73 Recognition unit
201 Information processing unit
202 Wiping mechanism
203 Server
211 AI dirt detection unit
212 Image-change dirt detection unit
213 Dirt region identification unit
214 Communication control unit
215 Wiping control unit
231 Wiping determination unit
232 Wiping mechanism control unit
241 Image acquisition unit
242 AI dirt discriminator
243 Dirt region acquisition unit
251 Image acquisition unit
252 Image-change dirt discriminator
253 Dirt region acquisition unit
261 Matching unit
262 Sensor linkage unit
263 Determination unit
301 Information processing unit
311 AI backlight detection unit
312 Backlighted region identification unit
313 Communication control unit

1. An information processing device comprising:
a first detection unit that detects an adhering substance on a lens of a camera provided in a vehicle from a captured image captured by the camera using a first discriminator using a neural network;
a second detection unit that detects the adhering substance from the captured image using a second discriminator using an optical flow; and
a region identification unit that identifies a region of the adhering substance in the captured image on a basis of a first detection result by the first detection unit and a second detection result by the second detection unit.

2. The information processing device according to claim 1, wherein
the region identification unit identifies, as a region of the adhering substance, a region in the captured image detected as the adhering substance by at least one of the first detection unit or the second detection unit.

3. The information processing device according to claim 2, wherein
the region identification unit identifies, as a region of the adhering substance, a region in which a region in the captured image detected as the adhering substance by the first detection unit matches a region in the captured image detected as the adhering substance by the second detection unit.

4. The information processing device according to claim 3, wherein
on a basis of sensor data of an external recognition sensor used to recognize a situation outside the vehicle, the region identification unit separates a first erroneous detection region that is an erroneous detection region from a region in the captured image detected as the adhering substance by the first detection unit and separates a second erroneous detection region that is an erroneous detection region from a region in the captured image detected as the adhering substance by the second detection unit as the adhering substance.

5. The information processing device according to claim 4, further comprising a communication control unit that transmits the captured image including the first erroneous detection region to a server that performs learning using the neural network.

6. The information processing device according to claim 5, wherein
the communication control unit transmits the captured image including a region that is not detected by the first detection unit as a region of the adhering substance and is detected by the second detection unit as a region of the adhering substance to the server.

7. The information processing device according to claim 6, wherein
the first detection unit detects the adhering substance from the captured image using the first discriminator obtained by learning using the captured image transmitted to the server as learning data.

8. The information processing device according to claim 1, further comprising a wiping control unit that controls a wiping mechanism for wiping off the adhering substance according to the first detection result and the second detection result.

9. The information processing device according to claim 8, wherein
after operating the wiping mechanism, the wiping control unit determines whether or not the adhering substance has been wiped off on a basis of at least one of the first detection result or the second detection result.

10. The information processing device according to claim 9, wherein
the wiping control unit determines whether or not the adhering substance has been wiped off on a basis of only the first detection result for a predetermined period after the wiping mechanism is operated.

11. The information processing device according to claim 9, wherein
the region identification unit sets a region excluding a region of the adhering substance in the captured image as a recognition region used for recognizing an object around the vehicle.

12. The information processing device according to claim 11, wherein
the region identification unit updates a region where the wiping control unit determines that the adhering substance has been wiped off as the recognition region.

13. The information processing device according to claim 11, further comprising a recognition unit that recognizes the object from the recognition region of the captured image.

14. The information processing device according to claim 11, further comprising an operation control unit that controls an operation of the vehicle on a basis of the region of the adhering substance identified by the region identification unit.

15. The information processing device according to claim 14, wherein
the operation control unit moves the vehicle in a direction in which the object within an angle of view of the captured image and outside the recognition region appears in the recognition region.

16. The information processing device according to claim 14, wherein
the operation control unit moves the vehicle in a direction in which the object in the recognition region of the captured image is estimated to appear in the recognition region in the future.

17. An information processing method comprising:
detecting an adhering substance on a lens of a camera provided in a vehicle from a captured image captured by the camera using a first discriminator using a neural network;
detecting the adhering substance from the captured image using a second discriminator using an optical flow; and
identifying a region of the adhering substance in the captured image on a basis of a first detection result using the first discriminator and a second detection result using the second discriminator.

18. A computer-readable recording medium recording a program for performing processing of:
detecting an adhering substance on a lens of a camera provided in a vehicle from a captured image captured by the camera using a first discriminator using a neural network;
detecting the adhering substance from the captured image using a second discriminator using an optical flow; and
identifying a region of the adhering substance in the captured image on a basis of a first detection result using the first discriminator and a second detection result using the second discriminator.

19. An in-vehicle system comprising:
a camera that captures an image of a periphery of a vehicle; and
an information processing device that includes
a first detection unit detecting an adhering substance on a lens of the camera from a captured image captured by the camera using a first discriminator using a neural network,
a second detection unit detecting the adhering substance from the captured image using a second discriminator using an optical flow, and
a region identification unit identifying a region of the adhering substance in the captured image on a basis of a first detection result by the first detection unit and a second detection result by the second detection unit.
